(19) United States
(12) Patent Application Publication
(10) Pub. No.: US 2026/0062565 A1
(43) Pub. Date: Mar. 5, 2026

(54) SELF-DISINFECTING AND PATHOGEN ERADICATING COATING WITH SPORE GERMINATION AGENT, ARTICLE COMPRISING THE COATING AND METHOD OF APPLICATION

(71) Applicant: KISMET TECHNOLOGIES INC., Orlando, FL (US)

(72) Inventors: Christina H. Drake, Winter Park, FL (US); Scott Hoos, Apollo Beach, FL (US); Christopher S. Coughlin, Orlando, FL (US)

(21) Appl. No.: 19/105,852

(22) PCT Filed: Aug. 23, 2023
(86) PCT No.: PCT/US2023/030936

§ 371 Date: Feb. 24, 2025

Related U.S. Application Data
(60) Provisional application No. 63/400,273, filed on Aug. 23, 2022.
(60) Provisional application No. 63/403,111, filed on Sep. 1, 2022.
(60) Provisional application No. 63/446,825, filed on Feb. 18, 2023.

(51) Int. Cl. C09D 7/62; C09D 5/14; C09D 7/40; C09D 7/63

(52) U.S. Cl. CPC C09D 7/62; C09D 5/14; C09D 7/63; C09D 7/67

(57) ABSTRACT

A coating composition that includes a mixture of a water-based coating polymer, an aqueous solution having silver-modified ceria nanoparticles (AgCNPs) and a weight percent loading less than about 3% weight/volume of the mixture, and a spore germination agent having a 0.1-1% weight/volume and the mixture configured for coating a surface.

### BACKGROUND

Embodiments relate to the field of medical science and, more specifically, the field of continuous self-disinfecting and pathogen eradicating coatings using a water-based polymer coating composite with metal-modified nanoparticles and a spore germination agent. The embodiments relate to an article of manufacture that includes a continuous self-disinfecting and pathogen eradicating coating.

The transmission of nosocomial pathogens within hospitals is largely due to spread by healthcare workers' hands as they touch multiple surfaces and patients. For example, methicillin-resistant Staphylococcus aureus (MRSA) contamination of door handles in hospitals has been estimated between 1 and 6×10³ CFU (colony forming units). The presence of blood and pus, protein, serum, and sputum provides organic protection that significantly increases bacterial survival and persistence on a surface for up to two weeks in some cases. Unlike bacteria, viruses present unique issues in disinfection.

Bacteria are living cells and must have conditions present for the bacteria to continue to thrive. Residual sanitizers, such as Microban24, suppress conditions for survival and growth of bacteria, but do not kill viruses. Viruses are non-living and can remain infective if they remain intact until they reach a host.

Disinfectants deal with “deactivating” viruses as well as bacteria. Current spray disinfectants only disinfect at the time of application and do not provide protection after application. This creates a situation where areas with high touch surfaces or high patient throughput need to constantly have disinfectant reapplied to stop pathogen spread. The use of ultraviolet (UV) lights has a similar shortcoming to spray disinfectants in that they only disinfect when they are in use. Because UV light is not safe for exposure to humans, it cannot be used when people are present. This creates a high chance for infection to be spread by contact with surfaces in emergency rooms, intensive care units, and other healthcare scenarios where people are constantly present.

Clostridioides difficile infection (CDI) is a well-known cause of health care-associated diarrhea. Clostridioides difficile is an anaerobic gram-positive spore-forming bacterium. In severe cases, CDI can develop into pseudomembranous colitis, which can be lethal. [D. Zhu et al., “Clostridioides difficile Biology: Sporulation, Germination, and Corresponding Therapies for C. difficile Infection,” © February 2018, vol. 8, article 29, Frontiers in Cellular and Infection Microbiology.] Because Clostridioides difficile spores can survive for months on contaminated surfaces and tools, it is a problem for healthcare institutes, especially when outbreaks of virulent strains occur. These spores are extremely difficult to kill even with aggressive bleach and UV treatment, due to its complex and rigid coating structure.

Death rates for Clostridioides difficile infections can approach 30% for strains that are antibiotic resistant. Clostridioides difficile is an anaerobic bacterium and sporulates once outside of the body in order to survive in air. These spores can last for months to years and spread easily through places like hospitals. Currently, many hospitals use a 2-step bleach treatment, sometimes in conjunction with a UV light, to try and kill off Clostridioides difficile (hereinafter sometimes referred to as “C. diff”) spores. This thorough disinfection process can only be done when people are not present, presenting many opportunities for the spores to exit the bathroom (footwear, unwashed hands) and make their way onto other surface.

Other pathogens include Histoplasma capsulatum, which is a spore forming pathogen that can cause several different classes of disease depending on where it infects within the body as described in J. Mittal, et al., “Histoplasma Capsulatum: Mechanism for Pathogenesis,” copyright 2019, Curr. Top Microbiol Immunol; 422, 157-191 (doi:10.1007/82_2018_114). It shifts to yeast form in the presence of cysteine and sulfhydryl compounds if it is able to evade the body's immune response upon initial entry. Histoplasma capsulatum has a similar pathogenesis to C. diff. in terms of evasion in the environment and then evasion until it gets to a proper location in the body where it can easily infect.

### BRIEF SUMMARY

The embodiments relate to a continuous self-disinfecting and pathogen eradicating coatings using a water-based polymer coating composition with metal-modified nanoparticles and a spore germination agent and method of disinfecting a surface. The embodiments relate to an article of manufacture that includes a continuous self-disinfecting and pathogen eradicating coating on an article during manufacture of the article or after the article is installed in an environment.

The coating composition may comprise a mixture of a water-based coating polymer; an aqueous solution having silver-modified ceria nanoparticles (AgCNPs), and a spore germination agent wherein the AgCNPs ingredient having a weight percent loading less than about 3% weight/volume and the spore germination agents having a 0.01-3% weight/volume and the mixture configured for coating surfaces.

The embodiments related to an article of manufacture includes a continuous self-disinfecting and pathogen eradicating coating on a surface of the article. The surface may be hard or soft.

In an aspect, an article of manufacture is provided that comprises an object having a surface; and a coating composition is cured and bonded to the surface. The composition has AgCNPs and spore germination agents.

A method of disinfecting a surface comprises coating the surface with a coating composition with silver-modified ceria nanoparticles (AgCNPs) and a spore germination agent, and curing the coating composition to form a self-disinfecting coating on the surface which eradicates bacteria biofilms at least by 99.9% or >99.999%. The coating composition may be cured with a UV light or harden by drying.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a surface of an article coated with a coating composition in accordance with one embodiment.

FIG. 2A illustrates a toilet seat coated with a coating composition in accordance with one embodiment.

FIG. 2B illustrates a door with a door handle coated with a coating composition in accordance with one embodiment.

FIG. 3A illustrates furniture coated with a coating composition in accordance with one embodiment.

FIG. 3B illustrates fabric coated with a coating composition in accordance with one embodiment.

FIG. 3C illustrates an interior wall of a building coated with a coating composition and having a door and a window in accordance with one embodiment.

FIG. 4 illustrates a flowchart of a process for coating a surface in accordance with one embodiment.

FIG. 5 illustrates a graph of a vital titer such as rhinovirus over treated with AgCNP2 in accordance with one embodiment.

FIG. 6 illustrates three graphs of MSRA, staphylococcus aureus, and pseudomonas aeruginosa treated with AgCNP2 in accordance with one embodiment.

FIG. 7 illustrates a bar graph pseudomonas aeruginosa biofilm treated with AgCNP2 in accordance with one embodiment.

FIGS. 8A-8C illustrate a process for destroying Clostridioides difficile spores.

FIG. 9A illustrates a graphical representation of a R20291 (Clostridioides difficile) in a Brucella medium treated with AgCNP2 in accordance with one embodiment.

FIG. 9B illustrates a graphical representation of a R20291 (Clostridioides difficile) in a Brucella medium treated with AgCNP2 in accordance with one embodiment.

FIG. 10 illustrates a graphical representation of Clostridioides difficile (American Type Culture Collection (ATCC) 43598™) at 0.08 mg/mL treated with AgCNP2 in accordance with one embodiment.

FIG. 11 shows sporicidal efficacy of dried AgCNP2 with co-germinants Taurocholic Acid and Glycine that have been dried on glass slides.

FIG. 12A illustrates a vessel in accordance with one embodiment.

FIG. 12B illustrates a first vessel filled with synthesizing solution and precipitates in accordance with one embodiment.

FIG. 12C illustrates a second vessel filled with synthesizing solution and particulates in accordance with one embodiment.

FIG. 13 illustrates a system for the peroxy ligand conversion to silver-mediated cerium oxide nanoparticles according to one embodiment.

FIG. 14A illustrates a first closed system in accordance with one embodiment.

FIG. 14B illustrates a second closed system in accordance with one embodiment.

FIG. 15A illustrates a method for manufacturing AgCNP2 with a predominant 3+ surface charge in accordance with one embodiment.

FIG. 15B illustrates a flowchart of a process for forming an initial solution of FIG. 15A in accordance with one embodiment.

FIGS. 16A-16G illustrate images of different phases of the solutions of the method of FIG. 15A without heating.

FIG. 16A illustrates an image of a solution of cerium nitrate hexahydrate, silver nitrate, and hydrogen peroxide in a container at day 1 in accordance with one embodiment.

FIG. 16B illustrates an image of the solution of FIG. 16A after 2-4 days in accordance with one embodiment.

FIG. 16C illustrates an image of the solution of FIG. 16A after 4-5 days in accordance with one embodiment.

FIG. 16D illustrates an image of the solution of FIG. 16A after 45-60 days in accordance with one embodiment.

FIG. 16E illustrates an image of the solution of FIG. 16A after 75-90 days in accordance with one embodiment.

FIG. 16F illustrates an image of the solution of FIG. 16A after 90-120 days in accordance with one embodiment.

FIG. 16G illustrates an image of the solution of FIG. 16A after 120 days in accordance with one embodiment.

FIG. 17A illustrates an image of an aged solution including non-ionizing silver in a container after 3 months using the method of FIG. 15A with heat in accordance with one embodiment.

FIG. 17B illustrates an image of an aged solution including non-ionizing silver after 7 months in a container using the original synthesis process.

FIGS. 18A, 18B and 18C illustrate images of Escherichia Coli (E. Coli) liquid tests based on the aged solution of FIG. 17A using 0.05 mg/mL of AgCNP2 in accordance with one embodiment.

FIGS. 18D, 18E and 18F illustrate images of E. Coli liquid tests based on the aged solution of FIG. 17A using 0.1 mg/mL AgCNP2 in accordance with one embodiment.

FIGS. 18G, 18H and 18I illustrate images of E. Coli liquid tests based on the aged solution of FIG. 17A using 0.2 mg/mL AgCNP2 in accordance with one embodiment.

FIGS. 19A, 19B and 19C illustrate images of E. Coli liquid tests based on the aged solution of FIG. 17B using 0.05 mg/mL of AgCNP2 in accordance with one embodiment.

FIGS. 19D, 19E and 19F illustrate images of E. Coli liquid tests based on the aged solution of FIG. 17B using 0.1 mg/mL AgCNP2 in accordance with one embodiment.

FIGS. 19G, 19H and 19I illustrate images of E. Coli liquid tests based on the aged solution of FIG. 17B using 0.2 mg/mL AgCNP2 in accordance with one embodiment.

FIG. 20 illustrates a graph of superoxide dismutase (SOD) Enzyme Mimetic Assay for 0.2 mg/mL of AgCNP2 in accordance with one embodiment.

FIG. 21 illustrates a flowchart of a prior art method for forming AgCNP2.

FIG. 22 illustrates a flowchart of a method for forming AgCNP2 with heat in accordance with one embodiment.

FIG. 23 illustrates a table of ageing time relative to solution amount and form factor metrics in accordance with one embodiment.

FIGS. 24A-24J illustrate images of different phases of the solutions of the method of FIG. 15A without heating.

FIG. 24A illustrates an image of a solution of cerium nitrate hexahydrate, silver nitrate and hydrogen peroxide in a container in accordance with one embodiment.

FIG. 24B-24D illustrate images of the solution of FIG. 24A in different volume containers, large, medium, and small, at the end of day 1 in accordance with one embodiment.

FIG. 24E-24G illustrate images of the solution of FIG. 24A in different volume containers, large, medium and small, during day 3 in accordance with one embodiment.

FIG. 24H-24J illustrate images of the solution of FIG. 24A in different volume containers, large, medium, and small, during day 7 in accordance with one embodiment.

### DETAILED DESCRIPTION

The inventor has surprisingly determined that silver-modified cerium oxide nanoparticles (AgCNPs), as described herein, mixed with a spore germination agent in NanoRAD coatings, described herein, provide non-stop, continuous protection against viruses and bacteria, even when a surface is not pristine (free from organic matter). This is a common problem with many disinfection approaches that lose efficacy when protective organic matter is present with the bacteria or virus.

NanoRAD coatings provide continuous virus and bacteria protection even when the surface is not pristine and has organic matter present that typically protects bacteria and viruses. NanoRAD coatings also prevent biofilm formation and decrease existing biofilms. Because of how long the NanoRAD coatings are present on a surface, a method is included for validation of coating coverage after several weeks or months of use.

The inventor has surprisingly determined that NanoRAD coatings have the ability to eradicate pathogens (including MRSA and norovirus) even with repeat exposure to a full viral or bacterial load on a non-pristine NanoRAD treated surface within 2 hours. NanoRAD coatings are also able to disinfect in the presence of biofilms, with eventual eradication of even aggressive biofilms. NanoRAD coatings are intended for use from months up to several years (depending on the specific coating formulation) and are able to resist even wet chemical abrasion with other disinfectants such as bleach or hydrogen peroxide without loss of performance. NanoRAD coatings make use of a fluorescing additive that is UV activated within the coating and emits visible light. Film coverage and amount can be identified using an image processing technique assessing brightness per area of the antimicrobial film. Alternate to a fluorescing additive, the NanoRAD coatings may make use of NIR to visible up-conversion nanomaterials (UCNPs).

NanoRAD coatings are unconventional in its ability to eradicate pathogens even with protective organic matter present, either on the surface or with the pathogen. This is typically where residual antimicrobial technologies fail to disinfect, much less eradicate pathogens. This is an important feature for surfaces in hospitals where you may have several different persons interacting with a surface before the surface can be cleaned or recleaned. NanoRAD coatings are able to work even under these tough conditions, drastically reducing the likelihood of infection.

The inventor has surprisingly determined that another aspect of the NanoRAD coatings is that it eradicates biofilms and prevents growth of new biofilms. This means that even on a surface with an existing biofilm present, if not removed before the NanoRAD coating is applied, would be eradicated by the NanoRAD coating.

Another unconventional aspect of NanoRAD coating is the ability to bleach or aggressively chemically clean the coating without losing coating integrity. This allows the NanoRAD coating to provide essentially continuous self-cleaning or self-disinfecting properties while enabling the NanoRAD coating to be cleaned of bodily fluids, other surface contaminates, or organic matter, during the useful life (UL) of the coating. During cleaning to remove organic material such as bodily fluids, light abrasion may be applied without affecting the effectiveness of the NanoRAD coating.

The NanoRAD coating, as described herein, is self-disinfecting and has the ability to eradicate biofilms or other bacteria on surfaces below the NanoRAD coating that may be present, which prevents the biofilm or bacteria from growing under the coating, through the coating or around edges of the coating.

The NanoRAD coatings, as described, herein have applications for public and private building, including hospitals, offices, hotels, residences, vacation rentals, retail stores, by way of non-limiting examples. NanoRAD coatings also have applications on ships and marine environments where eradication of pathogens is needed or prevention of colonization of a surface by bacteria or similar organism.

The inventor has also surprisingly determined that silver-modified cerium oxide nanoparticles (AgCNPs), as described herein, mixed with a spore germination agent that causes rigidly enclosed bacterium spores to germinate, making them highly susceptible to an antimicrobial, such as a dry antimicrobial. Then, the dry antimicrobial, such as the AgCNPs) in the coating, as described herein, eradicates the germinated bacteria.

NanoRAD coatings described herein is a coating that triggers spore germination, then allowing a low dose of antimicrobial within the coating to deactivate the germinated spore of the bacteria quickly and effectively on that surface from causing further infection.

The NanoRAD coatings described herein mimic conditions that cause C. diff spores to germinate so that the coating composite with a dry antimicrobial is able to effectively kill off germinated C. diff spores bacterium. This coating has repeat, residual efficacy, leading to eventual eradication of infective C. diff spores and bacteria on treated surfaces. This reduces the constant need for aggressive disinfection and works safely with people present. The spores landing on a surface coated with a cured coating composition germinate.

The NanoRAD coatings, as described, mimic conditions that cause Histoplasmosis capsulatum (www.ncbi.nlm.nih.gov/pmc/articles/PMC7212190) to germinate so that the coating composite with a dry antimicrobial is able to effectively kill off germinated Histoplasmosis capsulatum spores bacterium.

The inventors have surprisingly determined that silver-modified cerium oxide nanoparticles (AgCNP2) with predominantly 3+ Ce, as described herein, can be manufactured using a process with at least one accelerant that speeds up the peroxy ligand conversion to nanoparticles. The accelerant aids in evolving metal, such that metal (i.e., silver) precipitates evolve to a non-ionized metallic phase on the cerium oxide nanoparticles.

The inventors have surprisingly determined that silver-modified cerium oxide nanoparticles (AgCNP2), as described herein, can be manufactured using a process with at least one accelerant that speeds up the peroxy ligand conversion to nanoparticles. The at least one accelerant evolves silver, such as silver precipitates to a non-ionized silver metallic phase more rapidly than without the at least one accelerant.

The inventors have surprisingly determined that silver-modified cerium oxide nanoparticles (AgCNP2), as described herein, can be manufactured using a process with an accelerant that speeds up the peroxy ligand conversion to nanoparticles by effectuating quicker access to water or other processing aqueous solution, for example.

The inventors have surprisingly determined that AgCNP2, as described herein, can be manufactured using a process with an accelerant that speeds up the peroxy ligand conversion to nanoparticles by using low heat and specifically below the boiling point of water or other processing aqueous solution, for example.

The inventors have surprisingly determined that AgCNP2, as described herein, can be manufactured using a process with an accelerant that speeds up the peroxy ligand conversion to nanoparticles by using a vessel form factor with or without heat, the form factor that limits stacking and/or crowding of the crashed-out particulates to maximize the particulates' surface being in direct contact with the water or other processing aqueous solution.

The inventors have surprisingly determined that AgCNP2, as described herein, can be manufactured using a process with at least one accelerant that speeds up the peroxy ligand conversion to nanoparticles by using wholly un-stabilized hydrogen peroxide with or without heat.

The inventors have surprisingly determined that silver-modified cerium oxide nanoparticles (AgCNP2), as described herein, can be manufactured using a process with at least one accelerant that produces AgCNP2 nanoparticles with only non-ionizing silver in a single vessel without the need for removal from or repackaging of the final product of a colloidal solution of AgCNP2 nanoparticles, wherein the colloidal solution of AgCNP2 nanoparticles from the process has essentially all, to 1 ppm or less of the limit of detection, ionized silver removed.

The inventors have surprisingly determined that AgCNP2, as described herein, can be manufactured using a process in a closed system with at least one accelerant that produces AgCNP2 nanoparticles with only non-ionizing silver in a single vessel without the need for removal from or repackaging of the final product of a colloidal solution of AgCNP2 nanoparticles from the closed system, wherein the colloidal solution of AgCNP2 nanoparticles from the process has essentially all, to 1 ppm or less of the limit of detection, ionized silver consolidated into metallic silver and no longer present in the solution.

The inventors have surprisingly determined that AgCNP2, as described herein, can be manufactured using a process with at least one accelerant that produces AgCNP2 nanoparticles with only non-ionizing silver. At least one accelerant is low heat of 90-115° F. (or 32.2-46° C.) to speed up the ageing process wherein the ageing process is completed when all, to 1ppm or less of the limit of detection, ionized silver has been consolidated into metallic silver and no longer present in the solution.

The inventors have surprisingly determined that silver-modified cerium oxide nanoparticles (AgCNP2), as described herein, can be manufactured using the process the uses low heat of 90-115° F. (or 32.2-46° C.) over the aging period to speed up the ageing process by a factor of 6.

The inventors have surprisingly determined that AgCNP2, as described herein, can be manufactured using the process to rapidly evolve silver precipitates to a non-ionized metallic silver phase using very low heat as an accelerant.

The inventors have surprisingly determined that silver-modified cerium oxide nanoparticles (AgCNP2), as described herein, can be manufactured using the process that uses a vessel form factor as an accelerant that promotes a reduction in ageing time by a factor in the range of 3-60, depending on the vessel form factor used.

The inventors have surprisingly determined that silver-modified cerium oxide nanoparticles (AgCNP2), as described herein, can be manufactured using the process that uses a very low heating process as an accelerant to expedite the ageing process. However, the heating process, if done before particle crash-out, makes the process unviable when wholly un-stabilized hydrogen peroxide is not used as the source of hydrogen peroxide for the synthesis. Also, understanding the surface area to synthesis volume form factor (nanoparticle access to water to resuspend into solution) is another accelerant to aid in reducing aging time.

The inventors have surprisingly determined that silver-modified cerium oxide nanoparticles (AgCNP2), as described herein, can be manufactured using a process that was also not previously well understood where the end of the ageing process is after silver has evolved on the nanoparticle surface, not just at the end of particulate reprecipitation (when solution first goes clear).

The inventors have surprisingly determined that AgCNP2, as described herein, can be manufactured using the process to rapidly evolve silver precipitates on cerium oxide nanoparticles to eliminate remaining ionized silver for a solution forming the AgCNP2 without the need to wash the residual particles and remaining solution. The elimination of a washing step provides a more environmentally friendly process since added amounts of dH₂O or diH₂O used in washing can be eliminated. Additionally, the reduced cost of manufacturing AgCNP2 by the reduction in the amount of dH₂O or diH₂O used in the manufacturing process is also achieved by eliminating the need for discarding, processing, and/or handling of spent dH₂O or diH₂O that would have been added in a washing step to wash away remaining ionized silver, as the waste byproduct comprising dH₂O or diH₂O and ionized silver requires special handling that is very costly.

The inventors have surprisingly determined that AgCNP2 can be manufactured using a shortened process that does not require washing of residual particles and silver can rapidly evolve on to cerium oxide nanoparticles to eliminate the presence of remaining ionized silver in a shorter time period. The ability to shorten the manufacturing time to colloidal stability of the solution reduces the storage facility and climate control necessary to store the colloidal solution.

An initial (original) synthesis to produce a specialized form of Janus type metal (i.e., silver) mediated cerium oxide nanoparticles with predominantly 3+ Ce and super oxide dismutase (SOD) enzyme like behavior is described in WO2021222779A1, titled “Dispensable nanoparticle based composition for disinfection” which is incorporated herein by reference and ACS NANO, by Craig J. Neal, et al., titled “schemMetal-Mediated Nanoscale Cerium Oxide Inactivates Human Coronavirus and Rhinovirus by Surface Disruption,” copyright 2021 by American Chemical Society, and published Aug. 26, 2021.

The original synthesis to produce a tote cost approximately $1,080,140 to manufacture AgCNP2 with 1× concentration with a manufacturing time of 9-12 months. The original synthesis with 4× concentration cost approximately $4,320,411 and took over one year. The new synthesis described herein cost $400 and took 3 weeks to manufacture AgCNP2 at 1× concentration. The new synthesis described herein cost $1532 and took 5 weeks to manufacture AgCNP2 at 4× concentration. Table 1 provides a summary of the manufacturing differences between the original synthesis and the new synthesis.

TABLE 1

| Manufacturing for a | | | |
|---|---|---|---|
| 275 Gallon Tote | Cost | Manufacturing Time | |
| Original synthesis | $1.025M | 9-12 | months |
| (1x concentration) | $17k chemicals | | |
| | $8K water | | |
| | $1M waste disposal | | |
| Original synthesis | $4.3M | >1 | year |

| | | |
|---|---|---|
| (4x concentration) | $67k chemicals | |
| | $30k water | |
| | $4.2M waste | |
| | disposal | |
| New synthesis (1x | $400 | 3 weeks (low |
| concentration) | Total for chemicals | temperature heated with |
| | and water | wholly un-stabilized H2O2) |
| | No waste disposal | |
| | cost | |
| New synthesis (4x | $1.5k | 5 weeks (low |
| concentration) | Total for chemicals | temperature heated with |
| | and water | wholly un-stabilized H2O2) |
| | No waste disposal | |
| | cost | |

The inventor has surprisingly discovered a process to manufacture AgCNP2without the need for a washing process which produces a hazardous product requiring special waste disposal processes. The new processes described herein provides significant savings in money and water consumption, as well as eliminates the creation of a hazard material byproduct requiring waste disposal.

In the original synthesis the method for forming AgCNP2 includes about 109mg of cerium nitrate hexahydrate (99.999% purity) dissolved in about 47.75 mL dH₂O in a 50 ml square glass bottom. Then, about 250 μL of 0.2 M aq. AgNO₃ (99% purity) is added to the cerium solution above with the solution vortexed for 2 minutes: Machine: Vortexer. Then, about 2 mL of 3% hydrogen peroxide (stock) is added quickly to the above solution followed by immediate vortexing for 2 minutes at highest rotation speed (in vortexer machine). This solution is stored in dark condition at room temperature with the bottle (50 mL square bottom glass) cap loose to allow for release of evolved gases; solutions are left to age in these conditions for up to 3 weeks (monitoring solution color change from yellow to clear) to create 50 ml total volume of the solution. Particles are then dialyzed against 2 liters of dH2O over 2 days, (dialysis tubing) with the water changed every 12 hours and stored in the same conditions as for ageing. This process only produced approximately 50 mL.

This new synthesis provides a very cost-effective solution for the manufacture of AgCNP2 with predominantly 3+ Ce for use in a variety of products.

### Definitions

Unless specifically stated or obvious from context, as used herein, the term “about” is understood as within a range of normal tolerance in the art, for example, within 2 standard deviations of the mean. “About” can be understood as within 30%, 25%, 20%, 15%, 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

As used herein, the term “composition” or “composite” as used herein refers to a product that includes ingredients such as one or more of chemical elements, diluent, binder, additive, or constituent in specified amounts, in addition to any product which results, whether directly or indirectly, from a combination of the ingredients in the specified amounts.

The term “prevention” or “preventing” of a disorder, disease, or condition as used herein refers to, in a statistical sample, a measurable or observable reduction in the occurrence of the disorder, disease or condition in the treated sample set being treated relative to an untreated control sample set, or delays the onset of one or more symptoms of the disorder, disease or condition relative to the untreated control sample set.

As used herein, the term “subject,” “individual” or “patient” refers to a human, a mammal, or an animal.

The term “metal-modified cerium oxide nanoparticles,” “metal-modified ceria nanoparticles,” or “mCNPs” as used herein refers to cerium oxide nanoparticles coated with or otherwise bound to an antimicrobial promoting metal such as silver, gold, copper, platinum, nickel, zinc, iron, titanium, ruthenium, vanadium, and the like. The term “mCNPs” may include AgCNP2, as described herein, and sometimes referred to as a NanoRAD ingredient. In an embodiment, the metal-associated cerium oxide nanoparticles comprise a particle size in the range of 3 nm-20 nm, with a preferred range from 10 nm-20 nm. The term “mCNPs” may also include AgCNP1 (i.e., metal-associated cerium oxide nanoparticles) comprising a particle size or diameter in the range of about 15 nm to 25 nm. The mCNPs may include metal-associated cerium oxide nanoparticles with a preferred range of 25 nm to 35 nm. AgCNP1, as described herein, may sometimes be referred to as a NanoRAD ingredient. The “mCNPs,” as described herein, are a NanoRAD ingredient.

The term “silver-modified cerium oxide nanoparticles,” or “AgCNP2” as used herein refers to cerium oxide nanoparticles with predominantly 3+ Ce coated with or otherwise bound to an antimicrobial promoting metal such as silver. In an embodiment, the silver-associated cerium oxide nanoparticles with predominantly 3+ Ce comprise a particle size in the range of 3 nm-35 nm, with a preferred range from 10 nm-20 nm.

As used herein, the term closed system is a physical system that does not transfer matter in or out of the system during the aging process to evolve all (below the limit of detection) ionized silver (Ag) to crystallize onto cerium oxide nanoparticles. At the end of the aging process there is no waste byproduct that is greater than 1 ppm of ionized silver that requires removal or washing.

As used herein “all ionized silver removed” means that the ionized silver is removed to the ppm range (as a residual if not totally removed, i.e., hard to detect). Ionized silver can have a limit of detection (LOD) of 1 ppm. The term “all ionized silver removed” means the ionized silver is at or less than 1 ppm (i.e., below the LOD).

As used herein, the term AgCNP ingredient includes an aqueous solution that include AgCNP with 1 ppm or less of the limit of detection of ionized silver present.

As used herein, the term accelerant causes evolution of all, to 1 ppm or less of the limit of detection, ionized silver (Ag) to crystallize onto cerium oxide nanoparticles as a non-ionized metallic silver phase at a quicker rate (less time to age) than a process that does not use the accelerant.

As sometimes used herein, cerium oxide nanoparticles is referred to as “nanoceria.”

The term “predominant 4+ surface charge” refers to the concentration of cerium ions on the surface and means that the [Ce3+]:[Ce4+] ratio on the surface of the cerium oxide nanoparticle is less than 50%. In a specific example, cerium oxide nanoparticles having a predominant 4+ surface charge have a [Ce3+]:[Ce4+] ratio that is 40% or less. The term “predominant 3+ surface charge” means that the [Ce3+]:[Ce4+] ratio on the surface of the cerium oxide nanoparticle is greater than 50%. The term “predominant 3+ surface charge” means that the [Ce3+]:[Ce4+] ratio on the surface of the cerium oxide nanoparticle is greater than 50%. In a specific example, the [Ce3+]:[Ce4+] ratio is greater than 60%. The term “wet chemical synthesis” refers to a bottom-up method of making CNPs that involves dissolving a cerium precursor salt in water followed by addition of hydrogen peroxide. In a specific example, the CNPs form crystals and are stabilized over a predetermined timeperiod, typically at least 15-30 days.

The “spore germination agent” is in a solution that is effective in causing spores of Clostridioides difficile “to germinate.

The “spore germination agent” is in a solution that is effective in causing spores of Histoplasma Capsulatum to germinate.

The term “crash-out” as used herein refers to a process where something precipitates out of solution and collects at the bottom of the solution.

### Spore Germination Agent

The spore germination agent may include a solution of taurocholic acid (TCA)/cholic acid derivatives and amino acids (e.g., glycine or alanine), as described in D. Zhu et al., “Clostridioides difficile Biology: Sporulation, Germination, and Corresponding Therapies for C. difficile Infection,” copyright February 2018, vol. 8, article 29, Frontiers in Cellular and Infection Microbiology, incorporated by reference.

The spore germination agent may include a co-germinant.

In some embodiments, the co-germinant may include histidine, such as described in L. J. Wheeldon et al., “Histidine acts as a co-germinant with glycine and taurocholate for Clostridium difficile spores,” copyright 2011, J. Applied Microbiology, 110, pg. 987-994, (ISSN 1364-5072), incorporated herein by reference in full.

In terms of amounts, a spore germination agent may include a Bile Salt, the amount is about 0.01-3% wt./volume as an average across the different types of TCA/cholic acid derivatives as the initiator for germination.

For a spore germination agent that includes co-germinant amino acids, the range is about 0.01-1% wt./volume.

For a spore germination agent that includes glycine, the range is about 0.01-1% wt./volume.

For a spore germination agent that includes co-germinant acids, calcium (Ca²⁺) is in a range of 0.01% wt./volume up to 1% wt./volume.

The cholic acid derivatives include cholic acid, chenodeoxycholic acid, deoxycholic acid, ursodeoxycholic acid, taurocholic acid, glycocholic acid, tauro-chenodeoxycholic acid, glyco-chenodeoxycholic acid, tauro-deoxycholic acid, glyco-deoxycholic acid, tauro-ursodeoxycholic acid, and glyco-ursodeoxycholic acid. Related semisynthetic keto derivatives include 12-monoketocholic acid, 7-monoketocholic acid, 7,12-diketocholic acid, 3,7,12-triketocholic acid, and 12-monoketodeoxycholic acid.

The amino acid co-germinant may include glycine, polyglycine, taurine, polytaurine, L-alanine, poly (alanine), L-glutamine or poly (glutamine).

### Silver-Modified Cerium Oxide Nanoparticle (AgCNP1)

The metal modified CNPs are created using a forced hydrolysis reaction followed by a postsynthesis digestion process. The postsynthesis digestion process removes secondary silver phases. After the postsynthesis digestion process, ammonium hydroxide (NH₄OH) is added to dissolve silver (Ag) phases. The dissolved silver is subjected to centrifugation and then washed with distilled water (dH₂O).

### Silver-Modified Cerium Oxide Nanoparticle (AgCNP2)

Using a forced hydrolysis reaction, a solution containing silver-modified nanoceria and silver secondary phases were formed, hereinafter referred to as “material.” The material was washed with distilled water. Then the washed material is treated with ammonium hydroxide (NH₄OH). The material was also treated with a phase transfer complex: mediating aqueous dispersion of dissolved silver, (Ag[(NH₃)₂OH]_{aq}). After treatment, the treated material was washed again, such as by distilled water. Particle separation processes may be applied in lieu of a washing treatment. In another synthesis that yields silver modified nanoceria, silver nitrate (AgNO₃) and cerium (Ce) are dissolved to form a mixture. Then the mixture is dissolved by hydrogen peroxide (H₂O₂) which causes selective oxidation of Ce³⁺ over silver and the evolution of metallic silver phases on the ceria surface.

The formula properties for AgCNP1 and AgCNP2 are shown below in Table 1.

TABLE 1

| | | | Inorganic Crystal |
|---|---|---|---|
| | | | Structure |
| | | | Database |
| | AgCNP2 | AgCNP1 | No. (ICSD #) |
| Ce^{3+:}Ce⁴⁺ | 53.7 | 25.8% | |
| (% Ce³⁺)(%) | | | |
| [Ag]/Ag + Ce] by | 14.6 | 16.9% | |
| XPS(%) | | | |
| SOD Activity (% | 99.2 | 97.9% | |
| Inhibition) | | | |
| Hydrodynamic Diameter | 31.6 ± 2.4 | 42.2 ± 4.6 | |
| (nm) | | | |
| Zeta Potential (mV) | 24.1 ± 1.3 | 22.4 ± 0.9 | |
| ICPMS Ce | 299.2 ± 1.3 | 342.5 ± 2.3 | |
| concentration (ppb) | | | |
| ICPMS Ag | 74.9 ± 1.21 | 24.1 ± 1.03 | |
| concentration (ppb) | | | |
| E_{corr} (mV) | 217.374 | 465.386 | |
| Metallic Ag | | | 44387 |
| CeO₂ | | | 55284 |

A Zeta-sizer nano was used from Malvern Instruments to determine hydrodynamic diameters and zeta potentials. Tafel analysis for AgCNP2 shows distinct corrosion potentials. E_{corr} values are substantially more noble than pure silver.

A more detailed description of the process for forming AgCNP2 will now be described. First, about 109 mg of cerium nitrate hexa-hydrate (99.999% purity) is dissolved in about 47.75 mL dH₂O in a 50 ml square glass bottom. Then, about 250 μL of 0.2 M aq. AgNO₃ (99% purity) is added to the cerium solution above with the solution vortexed for 2 minutes: Machine: Vortexer. Then, about 2 mL of 3% hydrogen peroxide (stock) is added quickly to the above solution followed by immediate vortexing for 2 minutes at highest rotation speed (in vortexer machine). This solution is stored in dark condition at room temperature with the bottle (50 mL square bottom glass) cap loose to allow for release of evolved gases; solutions are left to age in these conditions for up to 3 weeks (monitoring solution color change from yellow to clear) to create 50 ml total volume of the solution. Particles are then dialyzed against 2 liters of dH2O over 2 days, (dialysis Tubing) with the water changed every 12 hours and stored in the same conditions as for ageing.

The two unique formulations of cerium oxide nanoparticles are produced with surfaces modified by silver nanophases. Materials characterization shows that the silver components in each formulation are unique from each other and decorate the ceria surface as many small nanocrystals (AgCNP1) or as a Janus-type two-phase construct (AgCNP2). The average diameter of AgCNP1 is about 20 nm to 24 nm, and the average diameter of AgCNP2 is about 3 nm to 5 nm. However, the inventor prefers the use of AgCNP2. For example, AgCNP2 is preferred for high touch surfaces, including toilets, sinks, door handles, walls, faucets, hard surfaces, cages, etc. AgCNP1 may be used on floors, such as floors in public buildings, hospitals, restaurants, retail stores, government buildings, concert halls, or the like. AgCNP1 may be used on hard or soft surfaces with lower touch frequency by humans or animals. The AgCNP1 type NanoRAD ingredient may be a cheaper alternative to the AgCNP2 type NanoRAD ingredient and can be used in lieu of AgCNP2.

Each synthesis further possesses unique mixed valency with AgCNP2 possessing a significantly greater fraction of Ce3+ states relative to Ce4+ over AgCNP. The distinct valence characters, along with incorporation of chemically active silver phases, lead to high catalytic activities for each formulation. AgCNP2 possesses high superoxide dismutase activity, while AgCNP1 possesses both catalase and superoxide dismutase-like enzyme-mimetic activities, ascribed to the catalase activity of ceria and the superoxide dismutase activity from silver phases.

There are a variety of methods to synthesize nanoceria particles, including wet chemical, solvothermal, microemulsion, precipitation, hydrolysis and hydrothermal, such as described in S. Das, et al., “Cerium oxide nanoparticles: applications and prospects in nanomedicine,” Nanomedicine 8(9) (2013)1483-1508 and C. Sun, et al. “Nanostructured ceria-based materials: synthesis, properties, and applications,” Energy & Environmental Science 5(9) (2012)8475-8505, both of which are incorporated herein by reference. Based on the synthesis methodology employed, the size of these NPs varies broadly from 3-5 nm to over 100 nm, and the surface charge can vary from −57 mV to +45 mV.

Further, analysis demonstrates that silver incorporated in each formulation is substantially more stable to redox-mediated degradation than pure silver phases: promoting an increased lifetime in catalytic applications and low probability of ionization of the silver phase.

Use of AgCNP2 formulation in effecting antimicrobial properties showed specific activity in tests associated with bacteria with, among bacteria species tested, AgCNP2 showing substantial activity towards staphylococcus mutants, such as staphylococcus aureus.

Although the amount is not intended to be limiting, when used in methods of the invention, some preferred amounts of silver percentages associated with the AgCNPs are about 8% to 15% or less.

In other embodiments, disclosed is a method of producing mCNPs, as described herein, that may include the metal of silver. Further the AgCNP2 is produced via a method comprising dissolving cerium and silver precursor salts such as cerium and silver nitrates; oxidizing the dissolved cerium and silver precursor salts via admixture with peroxide; and precipitating nanoparticles by subjecting the admixture with ammonium hydroxide. Alternatively, the AgCNPs are produced via a method comprising (i) dissolving cerium and silver precursor salts such as cerium and silver nitrates; (ii) oxidizing and precipitating the dissolved cerium and silver precursor salts via admixture with ammonium hydroxide; (iii) washing and resuspending precipitated nanoparticles in water; (iv) subjecting the resuspended nanoparticles with hydrogen peroxide; and (v) washing the nanoparticles from step (iv) to remove ionized silver. For example, the removed ionized silver may be in the range of 3-5 nm in size.

In some embodiments, the AgCNP2 of the NanoRAD ingredient is produced via a method comprising dissolving cerium and silver precursor salts such as cerium and silver nitrates and oxidizing the dissolved cerium and silver precursor salts.

### Applications

The NanoRAD ingredient mCNPs, AgCNP1 or AgCNP2 can be combined into a composite with many forms of coating compositions for surfaces that may be applied to the surfaces of consumer products, medical product and especially surfaces with high touch exposure. The coating composites should be a water-based polymer.

The water-based coating polymer for coating surfaces of the coating compositions may include polyurethane coatings such as those manufactured by Sherwin-Williams as Clearcoat urethane products or Topcoat product for painting or covering surfaces of concreate, cabinets, automobiles, trucks, marine vehicles, aircraft vehicles and other surface compositions. A coating composition with a NanoRAD ingredient, such as mCNPs, AgCNP1 or AgCNP2, may be referred to as a NanoRAD coating or NanoRAD coating composition.

Coating formulation with about 3 weight % of AgCNP2 combined with about 0.01-3 weight % of co-germinants (taurocholic acid and glycine as example) in a water-based polymer coating (such as polyurethane or acrylic) provides simultaneous antibacterial and sporicidal activity against Clostridoides difficile.

The water-based coating polymer for coating surfaces of the coating composition may include paint. Paint may have pigmentation for coloring, additives, and binders. Paint may also have solvents and surfactants.

The NanoRAD ingredient mCNPs, AgCNP1 or AgCNP2 can be combined with POLYOX™ by DuPont, for example, to form a NanoRAD coating. The mCNPs, AgCNP1 or AgCNP2 may be combined with organic solvent-soluble polymers such as polyurethanes, acrylic polymers, polyamides, or combinations thereof to form a NanoRAD coating. An example of organic solvent-soluble polymers is described in U.S. Pat. No. 8,124,169, titled “ANTIMICROBIAL COATING SYSTEM,” assigned to 3M Innovative Properties Company, which is incorporated by reference and included in the Appendix. Examples of organic solvent-soluble polymers may include toluene, ESTANE® 5715, ESTANE® 5778, EPOXOL® CA118, NEOCRYL® XK-90, NEOCRYL® XK-95, NEOCRYL® XK-96, NEOREZ® R-960 AND NEOREX® R-9699. The NanoRAD ingredients of AgCNP1 or AgCNP2 may have a weight percent loading less than about 1 weight %.

The water-based coating polymer for coating surfaces of the coating composition may include cross-linkable polymer ingredients to form a durable coating layer upon evaporation of water, for example, such as the result of drying and/or curing the coating composition. An example of cross-linkable polymer ingredients is also described in U.S. Pat. No. 8,124,169.

The NanoRAD coating in some embodiments may be generally permanent until a coating remover is applied to the layer of coating composition in order to remove such coating composition. Light abrasion may cause wear to the NanoRAD coating which affects the useful life of the coating composition to be self-cleaning.

The water-based coating polymer for coating surfaces of the NanoRAD coating may include a colloidal polymeric medium such as a polyurethane, an acrylic, a polyester, a vinyl, or combinations thereof. The colloidal polymeric medium may have resin particles within a range of 1 micron or less in diameter, contingent on the ability to homogeneously distribute relatively evenly metal mediated nanoceria (i.e., NanoRAD ingredient) in the final coating medium. The NanoRAD ingredient may be mCNPs or AgCNP2 with a weight percent loading less than about 1 weight % and an average diameter between 25 nm to 35 nm. The NanoRAD ingredient may be mCNPs or AgCNP1 with a weight percent loading less than about 1 weight % and an average diameter of about 10 nm to 20 nm.

The NanoRAD coating may include a polyurethane coating, 30% solids, incorporating a NanoRAD ingredient, which are homogenized with relatively even distribution into a mixture. The NanoRAD ingredient may be mCNPs or AgCNP2 with a weight percent loading less than about 1 weight % and an average diameter of about 3 nm to 25 nm. The NanoRAD ingredient may be mCNPs or AgCNP1 with a weight percent loading less than about 1 weight % and an average diameter of about 20 nm to 50 nm.

The NanoRAD coating may be a polyester coating, 33% solids, used with a NanoRAD ingredient, which are homogenized with relatively even distribution into a mixture. The NanoRAD ingredient may be mCNPs or AgCNP2 with a weight percent loading less than about 1 weight % and an average diameter of about 3 to 25 nm. The NanoRAD ingredient may be mCNPs or AgCNP1 with a weight percent loading less than about 1 weight % and an average diameter of about 20 nm to 50 nm. By way of non-limiting example, the polyester coating may be applied to fibers found in fabrics, textiles, and carpet.

The water-based coating polymer for coating surfaces of the coating composition may include an acrylic coating, 30% solids, used with a NanoRAD ingredient, which are homogenized with relatively even distribution into a mixture of mCNPs or AgCNP2 with a weight percent loading less than about 1 weight % and an average diameter of about 3 to 25 nm. The NanoRAD ingredient may be mCNPs or AgCNP1 with a weight percent loading less than about 1 weight % and an average diameter of about 20 nm to 50 nm.

An example of colloidal polymeric mediums is described in U.S. Pat. No. 8,282,951, titled “ANTIMICROBIAL COATINGS FOR TREATEMENT OF SURFACES IN A BULIDING SETTING AND METHOD OF APPLYING SAME,” assigned to EnviroCare Corporation, which is incorporated herein by reference and included in the Appendix.

The coating compositions herein may include other ingredients such as, without limitations, a fluorescing additive that is UV activated within the coating and emits visible light when not activated. The fluorescing additive may fluoresce in the presence of a UV light so that the remaining useful life (RUL) of the coating may be seen. For example, the coated surface may be inspected daily, weekly, monthly, etc. The occurrence of a non-fluorescing area provides an indication of areas that needs a reapplication of the coating composition to maintain antimicrobial activity. In some embodiments, a region of interest (ROI) on the surface with the non-fluorescing area may be selected where only the non-fluorescing area is re-coated. In other embodiments, the cured coating in the ROI is removed and then a new layer of the coating is reapplied and cured. In other embodiments, the ROI is coated with a second layer of the coating to cover the non-fluorescing area.

Any of the NanoRAD coatings described herein may also include a fluorescing additive. The fluorescing additive may include orange, yellow, red, blue, green, pyranine, fluorescein or Rhodamine B pigment. An example of coating with a fluorescing additive is described in Australian Patent No. 656165, titled “A FLUORESCENT COATING,” which is incorporated herein by reference and included in the Appendix. The mCNPs, AgCNP1 or AgCNP2 may be combined, for example, in suitable coatings of paint that can be activated to fluoresce and to provide self-cleaning properties.

Any of the NanoRAD coatings described herein may include a near infrared (NIR) up-conversion salt or a visible up-conversion salt. The NIR up-conversion salt is hereinafter referred to as a “NIR additive.”

In the case of a NIR additive, the interrogating light may be a NIR light source so that the NIR additive has a visible emission. By way of non-limiting example, a doped NaYF₄ nanomaterial may be irradiated with a low power NIR light and then imaged to capture the infrared emission and its profile in red, green, blue (RGB) with a normal visible camera, where Na is sodium; Y is Yttrium; and F is Fluorine.

Any of the NanoRAD coatings described herein may include surfactants. The coatings may include ethyl ketone.

The water-based coating polymer for coating surfaces of the coating composition may include a nano composite photocatalytic containing solvents for rapid evaporation at room temperature, such as, polyalkylphenylsiloxane, xylene, nano densified hydrophilic fumed silica, and nanostructured composite photocatalyst powder. An example of photocatalytic composite is described in U.S. Publication No. 2007/0000407, titled “NANO COMPOSITE PHOTOCATALYTIC COATING,” to inventor Leong, which is incorporated herein by reference and included in the Appendix.

In some embodiments, the coating composition for the NanoRAD coating may include an epoxy with a surfactant.

The coating composition for the NanoRAD coating may be configured to provide an outer self-cleaning layer on a paper product. The coating composition may be an added ingredient to an outer protective layer to render the outer protective layer self-cleaning. While the outer protective layer may be cleaned of organic matter, the coating composition is continuously acting as a self-cleaner for the outer protective layer. An example protective layer is described in European Patent No. 2962858, titled “ANTIBACTERIAL COATING,” to Touch Guard Ltd., which is incorporated herein by reference and included in the Appendix. In lieu of antibacterial additives, the coating would instead use mCNPs, AgCNP1 or AgCNP2.

In some embodiments, the coating composition for the NanoRAD coating may include at least one of a stabilizer, pigment, organic filler, surfactant, polyvinyl alcohol polymethyl methacrylate, polymethyl-co-poly butyl methacrylate, thermosetting polymers, and epoxy resins.

The coating composition for the NanoRAD coating may include a sealant. varnish, resin, bonding agent, and coalescing solvent. Example methods for forming coatings are described in EP 1973587, titled “METHODS AND SYSTEMS FOR PREPARING ANTIMICROBIAL FILMS AND COATINGS,” to inventors Whiteford et al., which is incorporated herein by reference and included in the Appendix.

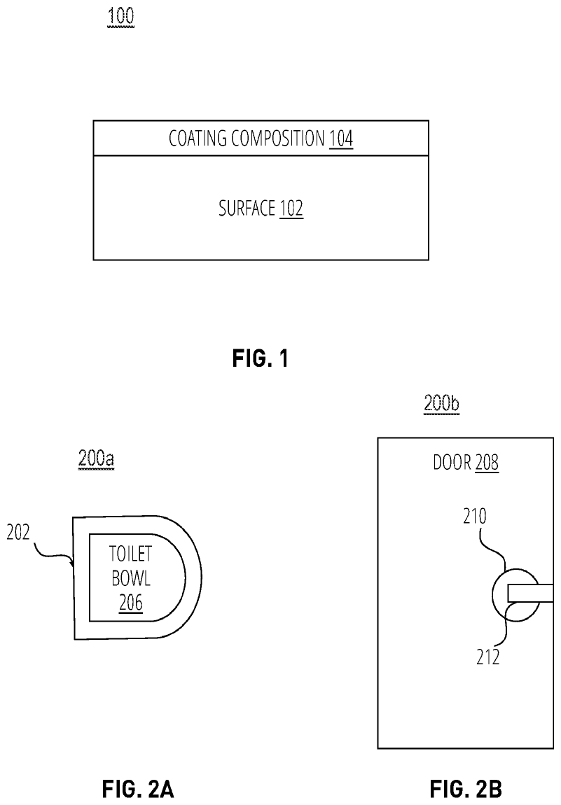

FIG. 1 shows a surface 102 of an article 100 coated with a coating composition 104 such as a NanoRAD coating, as described herein. The surface 102 may be any hard surface to make an article 100 such as cabinets, walls, sinks, toilets, countertops, floors, cars, ships, marine surfaces, computing devices, electronic devices, furniture, doorknobs, faucets, hospital beds, night tables, appliances, toys, and more. The surface 102 may include man-made materials, metal, porcelain, ceramic, cement, wood, engineered wood, and engineered synthetic materials, for example. The surface 102 may include a soft surface made of fibers, such as fabric, textile, and carpet. The water-based coating polymer for coating surfaces of the coating composition 104 may include clearcoat ingredients that are suitable for the particular surface application.

The soft surface may be made of fibers, paper or soft plastics or synthetic ingredients such as used to cover menus.

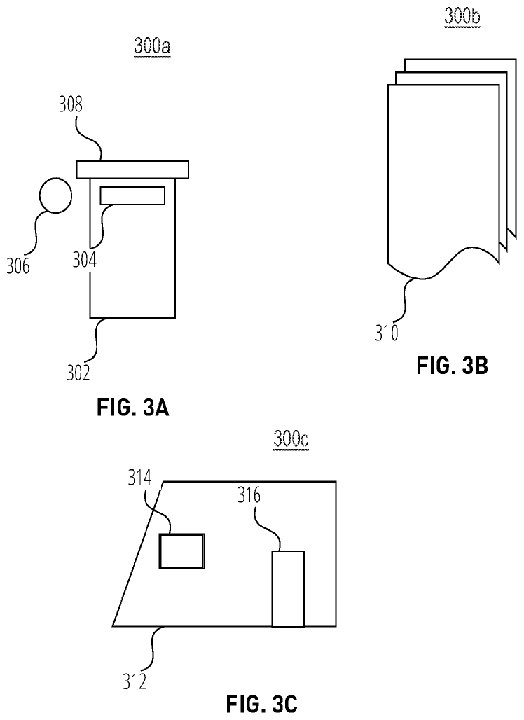

Example articles are shown in FIGS. 2A, 2B and 3A-3C. As should be understood, showing, and describing each and every possible article is prohibitive. An article includes an object that has a surface that is suitable for coating with a coating composition described herein.

FIG. 2A illustrates an article 200a that includes a toilet seat 202 coated with a coating composition, such as a NanoRAD coating, in accordance with one embodiment. The toilet seat 202 may be mounted on a toilet bowl 206. The toilet bowl 206 may be made of porcelain while the toilet seat 202 may be made of plastic, wood, or synthetic materials. Both the toilet seat 202 and toilet bowl 206 may be coated with different coating compositions 104.

FIG. 2B illustrates an article 200b that includes a door 208 with a door handle 212 affixed to a plate 210 in accordance with one embodiment. The door 208 may be coated with a first coating composition 104, such as a NanoRAD coating, while the door handle 212 and plate 210 may be coated with a second coating composition 104, such as another NanoRAD coating, different from the first coating composition. The first coating and the second coating may each include a spore germination agent and AgCNPs as described herein.

FIG. 3A illustrates an article 300a that includes furniture such as nightstand 306 and headboard 308 coated with a coating composition, such as a NanoRAD coating, in accordance with one embodiment. In some embodiments, the headboard 308 is attached to a bed 302 having a pillow 304. The nightstand 306 and headboard 308 may be coated with a coating composition 104. In some embodiments, the nightstand 306 and headboard 308 may be made of similar material which is suitable for using a coating composition 104 of the same type. In other instances, the nightstand 306 and headboard 308 may be made of different types of material requiring different NanoRAD coating compositions 104.

FIG. 3B illustrates an article 300b that includes fabric 310 coated with a NanoRAD coating in accordance with one embodiment. The fabric 310 may include fibers that are configured to be coated with a coating composition 104. The fabric 310 may be used for curtains, for example, in a hospital, office, hotel, public location, residence, or building. The fabric 310 may be used on soft surfaces, such as cushion chairs, sofas, beds, and the like.

The fabric 310 may be made into a paper product.

FIG. 3C illustrates an article 300c that includes an interior wall 312 of a building having a door 316 and a window 314 in accordance with one embodiment.

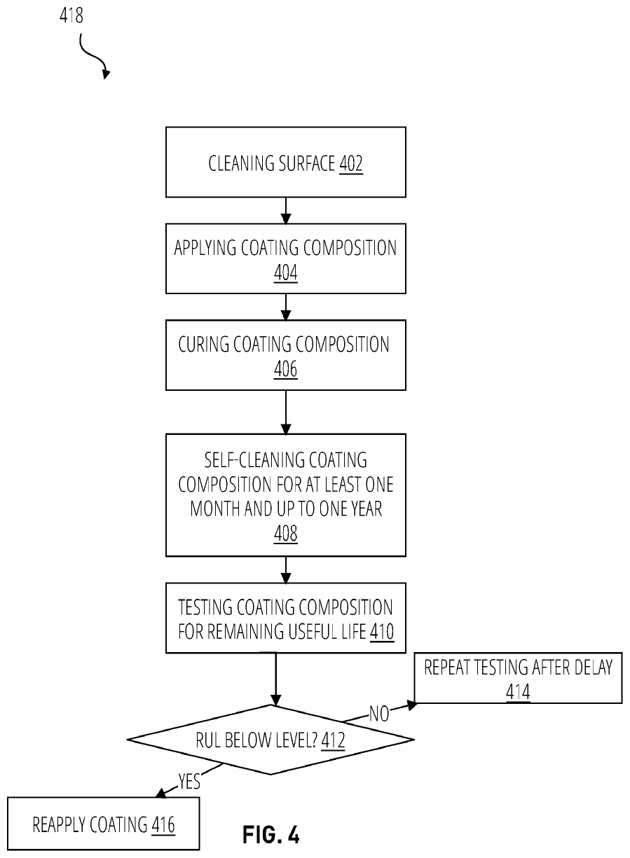

FIG. 4 illustrates a flowchart of a process 418 for coating a surface in accordance with one embodiment. The process 418, in block 402, may include cleaning a subject surface. While it may be recommended to clean the subject surface with a cleaner to remove bacteria and organic material, it may be impossible to remove all bacteria and resistant bacteria. The NanoRAD coating described herein eradicates bacteria and biofilms on the surface after the NanoRAD coating is applied and permanently affixed, for example.

In block 404, the process 418 may include applying a NanoRAD coating composition to the subject surface. In block 406, the process 418 may include curing or hardening the NanoRAD coating composition to form and affix the NanoRAD coating to the surface of the article. In some embodiments, the curing is performed using a UV light, for example, having a wavelength range of 200 nm to 400 nm. The NanoRAD coating composition 104 may harden or cure in response to an application of UV light in the wavelength range of 200 nm to 400 nm over a period of time. In other embodiments, the NanoRAD coating composition 104 may be hardened or cured in response to an evaporation of water or application of radiated heat.

In block 408, the process 418 may include continuously and autonomously self-cleaning and/or self-disinfecting the NanoRAD coating for at least one month and up to one year. In block 410, the process 418 may include testing the NanoRAD coating for remaining useful life (RUL). It should be understood that the NanoRAD coating may be cleaned using commercially available cleaners, such as those applied by spraying and wiping, to remove organic material that may be deposited from interaction with humans or animals. Such cleaning is secondary to the self-cleaning and/or self-disinfecting by the NanoRAD coating to eradicate bacteria, viruses, and biofilms, for example.

In decision block 412, a determination is made whether the RUL is below a level. If the determination is “NO,” then at block 414, the process 418 may include repeat testing after a delay, for example, testing may be repeated daily, weekly, monthly, quarterly, etc. The delay may vary based on the determined RUL level. If the determination is “YES,” then, at block 416, the process 418 may include reapplying the coating composition.

The RUL level may be determined using image processing, where the pixels are analyzed based on the appearance of the fluorescing additive. For example, in a region of interest (ROI), if 5% (RUL threshold) of the pixels are not fluorescing, the NanoRAD coating may need to have a new application of the NanoRAD coating over the existing NanoRAD coating. In other examples, the NanoRAD coating in the ROI is greater than the RUL threshold, the entire coating in at least the ROI may be removed so that a new NanoRAD coating can be reapplied. The RUL threshold may be between 5% and 10%. In other embodiments, the RUL threshold may vary based on the article and exposure to frequency of touch by humans or animals.

The coating method may be applied during the manufacturing process of a hard or soft surface article or in the building. In some embodiments, the coating may be sprayed on to the surface. In other embodiments, the coating may be applied in any manner as a paint is applied, such as with a paint brush. During the manufacturing process, the NanoRAD coating composition may be applied during an additive manufacturing process.

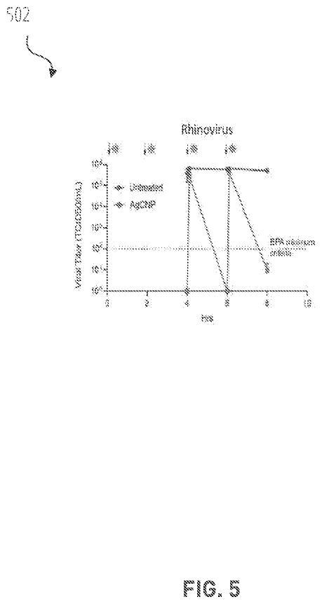

FIG. 5 illustrates a graph 502 of a viral titer such as rhinovirus over surface treated with AgCNP2 in accordance with one embodiment. The viral count (TCID50/ml) of a viral titer introduced at 0, 2, 4, and 6 hours to dry test surfaces, with infectious remaining virus analyzed at 4, 6, and 8 hours. Over time the untreated coupons with rhinovirus remains above 10⁵ between 4 and 8 hrs. verifying experimental controls. The graph 502 shows a paired film of metal-modified nanoceria (AgCNP2) taken at 4 hrs., 6 hrs., and 8hrs. At 4 and 6 hours the viral titer is non-detectable showing viral eradication. At the 8-hour mark (4 viral loads of >10⁵) was ˜10¹ (99.99% reduction), which is below the U.S. Environmental Protection Agency (EPA) minimum criteria (99.9%) for disinfection with residual antimicrobials.

FIG. 6 illustrates three graphs 602, 604 and 606 of MSRA, staphylococcus aureus, and pseudomonas aeruginosa, respectively, treated with AgCNP2 in accordance with one embodiment. The bacterial count (CFU/ml) is at least 10⁸ of a liquid bacterial load introduced to dry test surfaces at 0, 2, 4, and 6 hours, measured over time, for a control bacteria of MSRA, staphylococcus aureus, or pseudomonas aeruginosa, and a paired film of metal-modified nanoceria (AgCNP2). Bacterial count was analyzed at 2, 4, 6, and 8 hours. In the case of pseudomonas aeruginosa, eradication (>99.99999%) was seen at each time point. For MRSA and staphylococcus, eradication (>99.9999999%) at the 2 and 4-hour marks, while at the 6 and 8-hour mark, surviving bacteria was reduced by >99.999%. In each case, the bacteria paired with AgCNP2 reduced below the EPA minimum criteria (99.9% for disinfection with residual antimicrobials) and remained below the criteria at 2, 4, 6 and 8 hours for example.

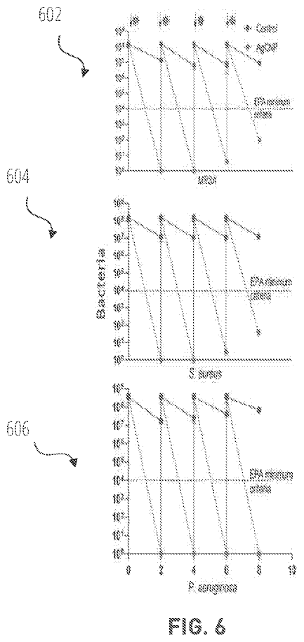

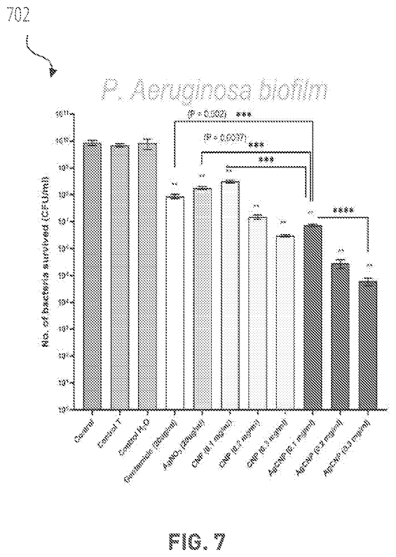

FIG. 7 illustrates a bar graph 702 of pseudomonas aeruginosa biofilm treated with AgCNP2 in accordance with one embodiment. The bacterial count (CFU/ml) of the test shows bars measurements for a control (LB agar), a control T (tris/NaCl), water (H₂O), gentamicin at 20 ug/ml (MIC), silver nitrate (AgNO₃) at 20 ug/ml (equivalent dose to silver in 0.2 mg/ml of AgCNP2), CNP at 0.1 mg/ml, CNP at 0.2 mg/ml, CNP at 0.3 mg/ml, AgCNP2 at 0.1 mg/ml, AgCNP2 at 0.2 mg/ml and AgCNP2 at 0.3 mg/ml. Reductions in survivable bacteria within the biofilm were monitored over a 3 day period. AgCNP2 (0.2 mg/ml) showed eradication of the biofilm by day 3, with a 99.99999999% reduction in survivable bacteria. Comparison was done with a non-metal mediated nanoceria (CNP) as well as an equivalent dose of silver salt to verify activity was due to metal mediation of nanoceria. AgCNP2 outperformed AgNO₃ CNP by ˜10,000× at the end of day 3.

Although the test results herein are for AgCNP2, the mCNPs or AgCNP1 ingredient is expected to also be self-disinfecting and eradication of biofilms.

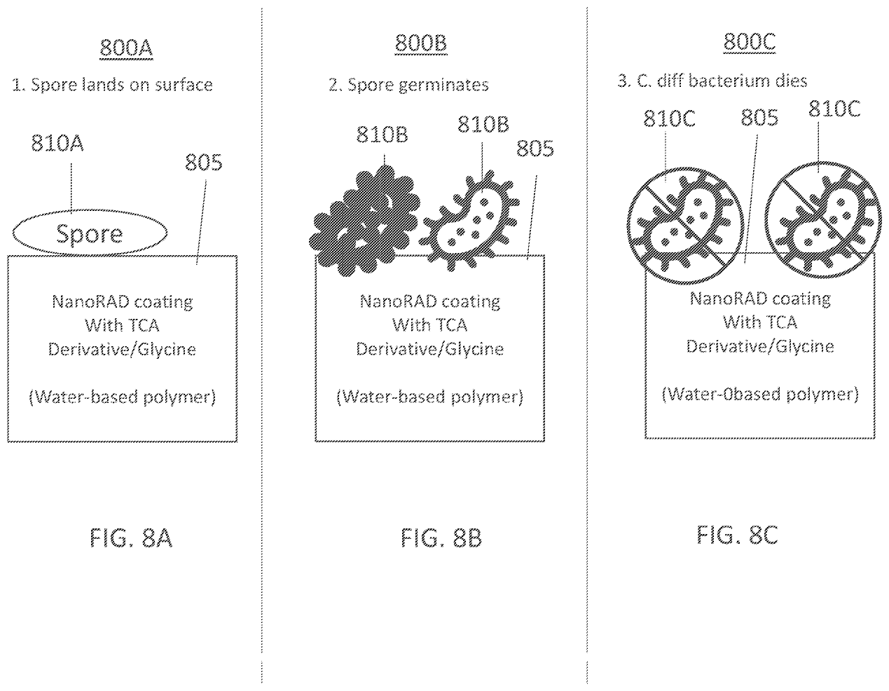

FIGS. 8A-8C illustrates a process for destroying Clostridioides difficile spores. FIG. 8A represents a first stage 800A where a bacterium spore 810A located on a NanoRAD coated surface 805 having a coating composition that is a water-based polymer is cured into a dry state. The NanoRAD coating (i.e., coating composition) may include AgCNP2 and a spore germinating agent such as without limitations, one or more of TCA/cholic acid derivative and glycine and histidine.

FIG. 8B represents a second stage 800B where the germination of spore 810A takes place to create one more germinated spores 810B. The spore 810A was caused to germinate from direct contact with the NanoRAD coated surface 805.

FIG. 8C represents a third stage 800C where the eradication takes place of the bacterium representative of the germinated spore 810C from the mCNPs with predominantly 3+ surface charge (i.e., AgCNP2) within the NanoRAD coating 805.

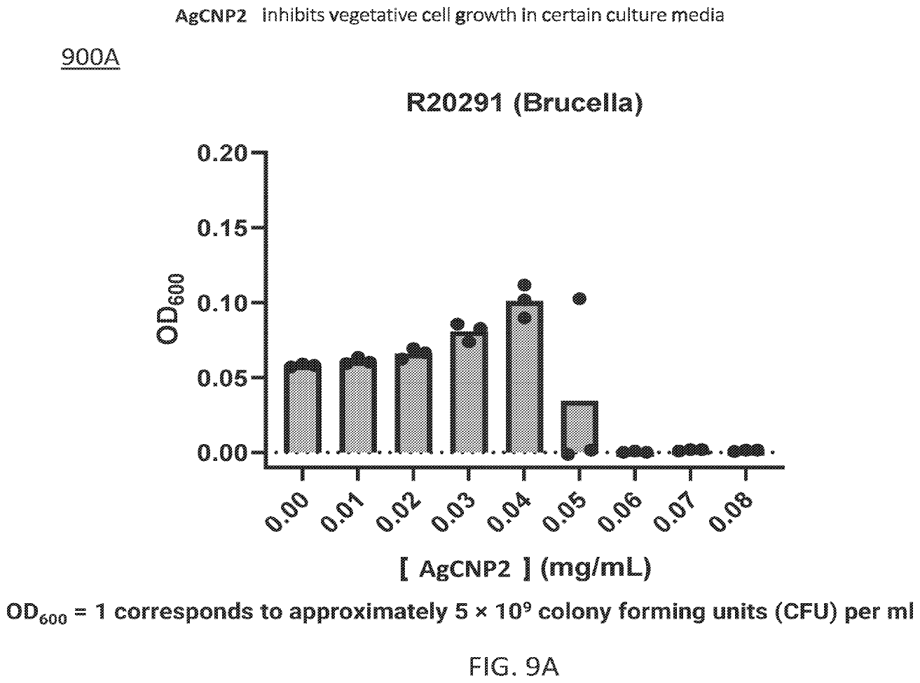

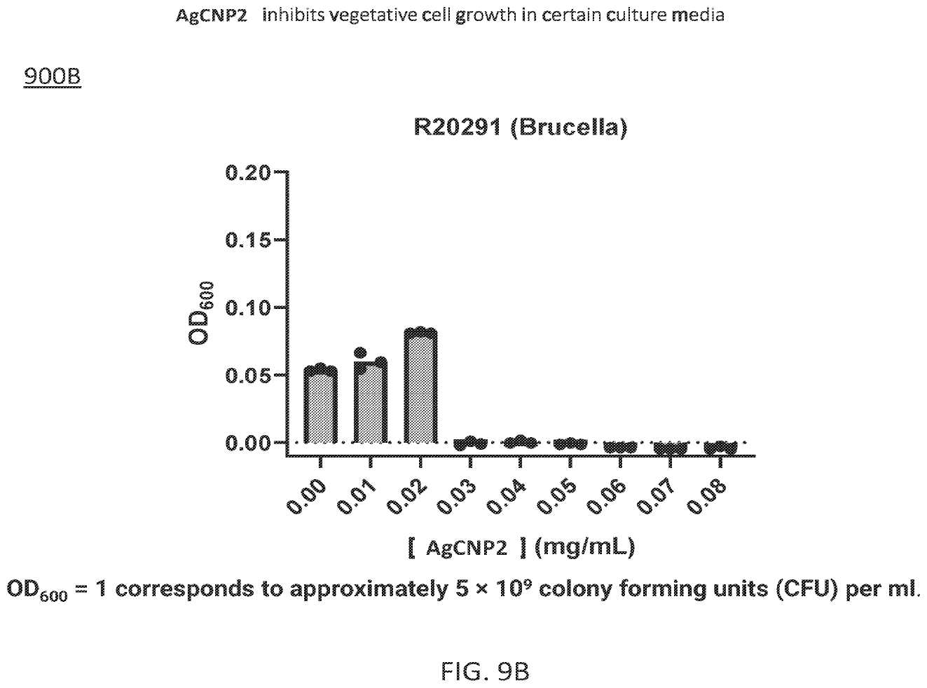

FIG. 9A illustrates a graphical representation 900A of a R20291 (Clostridioides difficile) in a Brucella medium treated with AgCNP2 in accordance with one embodiment. The graphical representation 900A illustrates amounts of the AgCNP2 in mg/mL being effective in amounts greater than 0.05 mg/mL in Brucella R20291 with OD₆₀₀=1 that corresponds to approximately 5×10⁹ colony forming units (CFU) per ml.

FIG. 9B illustrates a graphical representation 900B of a R20291 (Clostridioides difficile) in a Brucella medium treated with AgCNP2 in accordance with one embodiment. The graphical representation 900B illustrates amounts of the AgCNP2 in mg/mL being effective in amounts greater than 0.03 mg/mL in Brucella R20291 (National Center for Biotechnology Information (NCBI) Taxonomy database).

The inventor observes that the results varied on different days of testing which is likely due to not sonicating the nanomaterials beforehand.

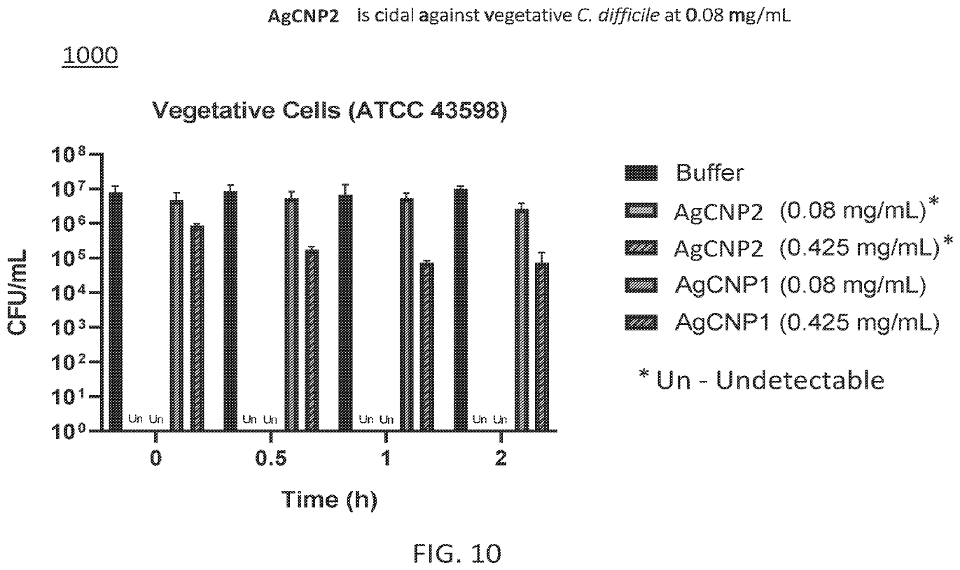

FIG. 10 illustrates a graphical representation 1000 of Clostridioides difficile (American Type Culture Collection (ATCC) 43598™) at 0.08 mg/mL treated with AgCNP2 in accordance with one embodiment. In the graphical representation 1000, testing was performed for mixtures of a buffer and vegetative cells ATCC 43598™, AgCNP2 and vegetative cells ATCC 43598™, and AgCNP2 and vegetative cells ATCC 43598™.

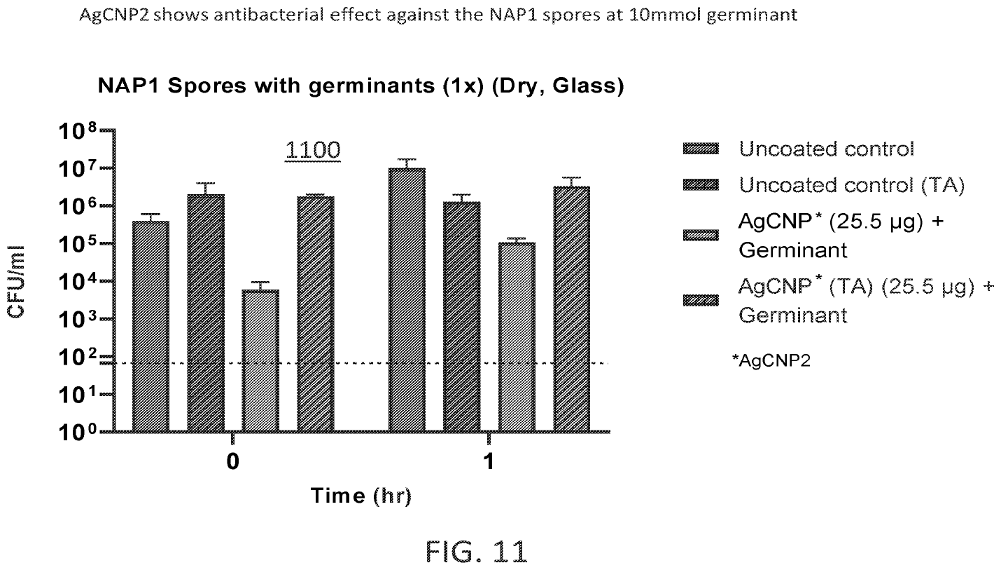

The vegetative cells ATCC 43598™ were undetectable (*UN) in solutions of AgCNP2 at 0.08 mg/mL and AgCNP2 at 0.425 mg/mL at times 0-2 hours. However, vegetative cells ATCC 43598™ were detectable in solutions with AgCNP1 at 0.08 mg/mL and 0.425 mg/ml at times 0-2 hours, with a reduction in vegetative cells ATCC 43598™ as time continued to 2 hours. FIG. 11 shows sporicidal efficacy of dried AgCNP2 with co-germinants Taurocholic Acid and Glycine that have been dried on glass slides. The blue bars represent an uncoated control of germinants only using NAPI Clostridoides Difficile spores. Those samples treated with Taurocholic Acid (TA), for example, are denoted in red bars with diagonal hatching.

The samples are plated on Brain Heart Infusion medium with yeast extract (BHIS) plates. The samples of the hatched fill bars were plated on BHIS (TA) plates.

The AgCNP2 (25.5 μg) with 10 mmol of co-germinants Taurocholic Acid and Glycine (dried on a glass coupon) showed sporicidal activity against NAP1 Clostridoides Difficile spores of ˜99% (2log reduction) by 1 hour.

The above description relates to, for example, existing non self-cleaning surfaces whether hard or soft.

A coating composition may comprise mCNPs ingredient having metal-associated cerium oxide nanoparticles and a paint. The metal can be selected from the group consisting of silver, gold, copper, platinum, nickel, zinc, iron, titanium, ruthenium, vanadium, and the like. However, because of the low cost of silver, silver is preferred.

A coating composition also may comprise a fluorescing additive or a NIR additive.

The metal comprises silver.

The coating composition may comprise the silver is in an amount of 10% or less by weight of the NanoRAD ingredient (i.e., mCNPs ingredient).

The coating composition may comprise AgCNP2 with a weight percent loading less than about 1 weight % and an epoxy.

The coating composition may comprise mCNPs ingredient with a predominantly 3+ surface charge and at least one of paint, epoxy, polyurethane, an acrylic, a polyester, and a vinyl.

The mCNPs ingredient may be AgCNP2 with a weight percent loading less than about 1 weight % and the mCNPs may have an average diameter of about 3 nm to 25 nm.

The coating composition may comprise mCNPs with predominantly 3+ surface charge, a fluorescing additive, and a UV curable epoxy where the mCNPs ingredient has a weight percent loading less than about 1 weight %.

The coating composition may comprise mCNPs ingredient with a predominantly 3+ surface charge and a colloidal polymeric medium where the mCNPs ingredient has a weight percent loading less than about 1 weight %.

The coating composition may comprise mCNPs with predominantly 3+ surface charge, a spore germination agent, and a cross-linkable polymer where the mCNPs ingredient has a weight percent loading less than about 1 weight %.

The coating composition may comprise mCNPs with predominantly 3+ surface charge, a spore germination agent, and a clearcoat urethane where the mCNPs ingredient has a weight percent loading less than about 1 weight %.

The coating composition may include at least one of a stabilizer, pigment, organic filler, surfactant, polyvinyl alcohol polymethyl methacrylate, polymethyl-co-poly butyl methacrylate, thermosetting polymers, and epoxy resins.

An article of manufacture comprises a hard surface having a NanoRAD coating thereon, the coating having a coating composition, as defined herein.

An article of manufacture comprises a soft surface having a NanoRAD coating thereon, the coating having a coating composition, as defined herein.

A method of disinfecting a surface comprises coating the surface with a NanoRAD coating, and curing the coating composition to form a self-disinfecting coating on the surface, the self-disinfecting coating on the surface eradicates bacteria biofilms at least by >99.999%. The coating may be cured with a UV light or harden by drying.

The inventors have determined that the initial (original) synthesis requires a long ageing time that increased in ageing time with increasing synthesis volume. Additionally, the initial synthesis required a water intensive washing step at the end of the ageing period that required a considerable amount of water (8 L for 50 ml of synthesized solution) that must then be treated as hazardous waste post synthesis. The new synthesis eliminates washing of the AgCNP2 by using at least one accelerant to evolve all the silver, such as silver precipitates to a non-ionized stable metallic phase on the cerium oxide nanoparticles.

The embodiments described herein provide a new synthesis process that reduces the time and cost to produce these nanoparticles (i.e., AgCNP2) with predominantly 3+ Ce in bulk. The new synthesis process provides 1) an increase in concentration of reactants per unit volume, and 2) elimination of the end washing step using at least one of a heating step to decrease the ageing time, a vessel form factor for decreasing ageing time, and wholly un-stabilized hydrogen peroxide, 3) significant reduction in the ageing time of the batch.

These improvements of the new synthesis drastically decrease the ageing time and cost for creation of Janus type metal mediated cerium oxide nanoparticles with predominantly 3+ Ce and super oxide dismutase (SOD) enzyme mimetic behavior.

This new synthesis allows for large scale production of a unique Janus type silver mediated cerium oxide nanoparticle colloidal in a reduced amount of time.

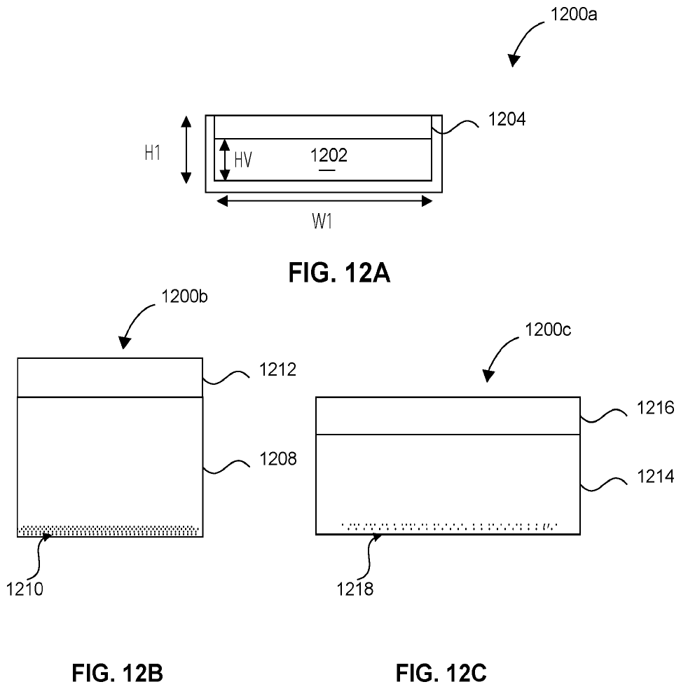

FIG. 12A illustrates a vessel 1200a in accordance with one embodiment. The vessel 1200a may be a first accelerant for use in a process with at least one accelerant that speeds up the peroxy ligand conversion to nanoparticles. The accelerant aids in evolution of metal, by increasing particulate access to water to more rapidly form cerium oxide, such that metal precipitates to a non-ionized stable metallic phase onto cerium oxide nanoparticles more rapidly, such as by a factor of 6, when compared to a process without a certain form factor. The vessel 1200a with a surface area to synthesis volume form factor that increases the area of nanoparticles able to access water (or aqueous solution) to undergo crystallization to a colloid and resuspend into the solution.

The vessel 1200a has an interior surface (IS) height H1 and an interior surface (IS) width W1. If the vessel 1200a is round, the IS width W1 may be an inner diameter (ID). The vessel 1200a has an IS height H1 that is smaller than the IS width W1 such that form factor (FF) ratio W1/H1>1. H1 describes the height on the volume of synthesis fluid in the container. For example, for the same vessel type, with a fixed height and diameter, decreasing the total reaction volume to a height in the vessel that achieves a ratio of W1/H1>1.

By way of non-limiting example, the vessel 1200a may have an IS height H1 and IS width W1 which are equal. However, the height of the volume HV of solution should be less than IS width W1 so that the FF ratio is W1/HV>1.

By way of non-limiting example, the vessel 1200a may have an IS height H1 that is larger than the IS width W1. However, the height of the volume HV of solution should be less than IS width W1 so that the FF ratio is W1/HV>1. This can be achieved by using about a third of the available height in the vessel, by example, so that the vessel becomes an accelerant.

In one example, the vessel is selected such that the FF ratio W1/HV is in the range of 0.20-0.50.

FIG. 12B illustrates a first vessel 1200b filled with synthesizing solution and precipitates in accordance with one embodiment. FIG. 12C illustrates a second vessel 1200c filled with synthesizing solution and precipitates in accordance with one embodiment.

FIG. 12B illustrates a first vessel 1200b with a width/height<1. The first vessel 1200b has an internal volume 1212 with portion 1208 filled with a synthesizing solution and crashed-out precipitates 1210 collecting in the bottom of the internal volume 1212. The width compared to the volume of the synthesizing solution causes stacking and crowding of the precipitates 1210 which causes the surface-to-surface contact of adjacent and surrounding precipitates, reducing particulate access to water. The points of the precipitate's surface that are in direct surface-to-surface contact with other precipitates do not have immediate and/or direct access to the synthesizing solution. The inventors have determined that crowding of the precipitates 1210 increases the ageing time because portions of the surface of particulates have limited access to the synthesizing solution, which delays the peroxy ligand conversion to silver-mediated cerium oxide nanoparticles as colloids in solution.

FIG. 12C illustrates the second vessel 1200c with a width/height>1 to increase the concentration of reactants per unit volume for access by the precipitates. In FIG. 12C, the second vessel 1200c has an internal volume 1216 with portion 1214 filled with a synthesizing solution and crashed-out precipitates 1218 collecting in the bottom of the internal volume 1216. The precipitates 1218 are shown to be less crowded. Therefore, less portions of the surface of the precipitates 1218 are in direct surface-to-surface contact with surrounding precipitates. As a consequence, the surface of the precipitates 1218 compared to surface of precipitates 1210 have an increase in access to the concentration of reactants per unit volume.

The form factor may be an important consideration especially for the manufacture of large volumes of silver-mediated cerium oxide nanoparticles, especially if a single vessel is used.

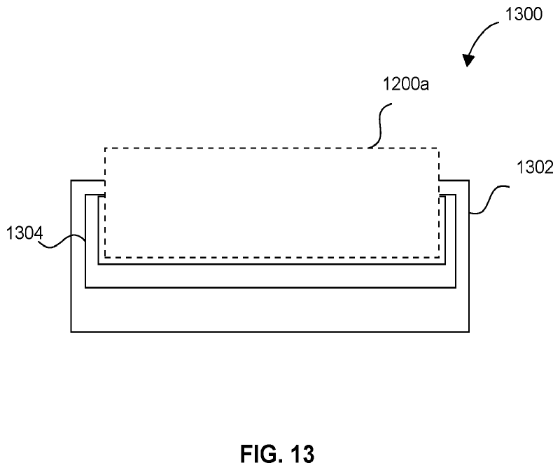

FIG. 13 illustrates a system 1300 for the proxy ligand conversion to silver-mediated cerium oxide nanoparticles according to one embodiment. The system 1300 may include vessel 1200a and heating device 1302. The bottom surface of vessel 1200a may be in direct contact with the heating surface 1304 of the heating device 1302. The heat from the heating device 1302 may be an accelerant to shorten the time for the peroxy ligand conversion to silver-mediated cerium oxide nanoparticles such that all the silver, such as silver precipitates evolve to a non-ionized metallic phase.

Both heating and the form factor of the vessel provide two accelerants to shorten the time for the peroxy ligand conversion to silver-mediated cerium oxide nanoparticles. The low heat applied to the vessel 1200a allows ageing to take place in a shorter time period as compared to other processes. In an embodiment that uses wholly un-stabilized hydrogen peroxide the time is shortened as well and crash-out precipitates are not formed. In such an embodiment, the application of heat can be applied immediately to speed up the peroxy ligand conversion to nanoparticles.

FIG. 14A illustrates a first closed system 1402 in accordance with one embodiment. The first closed system 1402 includes a vessel 1400a. The vessel 1400a is used as the container for mixing the solution to be aged. Once the ingredients are mixed, the vessel 1400a is closed for the duration of the aging process and until the aging process has completed with no detectable (less than or equal to 1 ppm) of waste byproduct of ionized silver. The closed system 1402 may shorten the time for the peroxy ligand conversion to silver-mediated cerium oxide nanoparticles such that all the silver, such as silver precipitates, evolve to a non-ionized metallic phase with at least one accelerant being the form factor of the vessel 1400a for use in the closed system. In another embodiment, an accelerant ingredient may be added to the solution, prior to forming the closed system.

The methods for manufacturing AgCNP2 with a predominant Ce 3+ charge is configured for closed system processing. A closed system minimizes introduction of contaminates since a single closed system vessel can be used throughout the manufacturing process to produce a volume of a colloidal composition of the manufactured AgCNP2 with a predominant Ce 3+ charge with all, to 1ppm or less of the limit of detection, ionized silver removed through conversion to metallic silver. The new synthesis eliminates the need to wash or any other post processing steps after all the silver is evolved to a non-ionizing metallic phase. Washing of AgCNP2 can lead to a decrease in the predominance of Ce 3+ charge to Ce 4+.

In some embodiments, a colloidal composition of the manufactured AgCNP2 with a predominant Ce 3+ charge and all, to 1 ppm or less of the limit of detection, ionized silver removed through full conversion to metallic silver can be manufactured in a vessel that is for example 250+ gallons and subsequently, sold and distributed (transported) using the same closed system vessel. The vessel may be approved for food grade applications meeting the Food and Drug Administration (FDA) regulations. The vessel 1400a may be made of polyethylene to hold a volume of fluid. The vessel 1400a may be supported by a cage 1408 and pallet 1410 made of steel, aluminum, or other metal. The vessel may include an inlet 1406, such as on top of the vessel, and an outlet (not shown).

An example vessel is an IBC tank with steel pallet, sold by ULINE, 12575 Uline Drive, Pleasant Prairie, WI, 53158. Another example vessel includes a 275 Gallon Rebottled IBC Tote that is sold by The Tank Depot, 658 John B Sias Memorial Parkway, Ste 330, Fort Worth, TX, 76134. Vessels of other sizes may be used that are smaller or larger than those described herein.

FIG. 14B illustrates a second closed system 1404 in accordance with one embodiment. The second closed system 1404 may include a vessel 1400b, shown in dashed lines. The vessel 1400b may be made of polyethylene configured to house a volume of a fluid or solution for the manufacture of AgCNP2 with a predominant Ce 3+ charge. The vessel 1400b may be supported by a cage 1412, shown in dashed line, which may be made of steel, aluminum, or other metal. The vessel 1400b may include an inlet, such as on top of the vessel, and an outlet (not shown). The cage and pallet may be designed to allow for stacking vertically, in some examples, of the vessel 1400b.

The vessel 1400b is used as the container for mixing the solution to be aged. Once the ingredients are mixed, the vessel 1400b is closed to form a closed system for the duration of the aging process and until no waste byproduct remains that is greater than 1 ppm of ionized silver. The closed system 1402 shortens the time for the peroxy ligand conversion to silver-mediated cerium oxide nanoparticles such that all the silver, such as silver precipitates, evolve to a non-ionized metallic phase with at least one accelerant. The accelerant may include the applied low heat created by the heating device 1416 surrounding the closed system (i.e., vessel 1400b) during the ageing process. The solution may be formed by adding a food grade hydrogen peroxide or a wholly un-stabilized hydrogen peroxide. In this instance, heat may be applied immediately by the heating device 1416 to the vessel of the closed system.

The second closed system 1404 may also include a heating device 1416. The heating device 1416 may include an IBC tote heater configured to wrap around vertical side of the cage and vessel. The IBC tote heater may be sold by The Tank Depot, 658 John B Sias Memorial Parkway, Ste 330, Fort Worth, TX, 76134. Another example is Global Industrial® Insulated Tote Heating Blanket For 275 Gal IBC Tote, Up To 145° F., 120V. The heating device 1416 may include a heating jacket that wraps around the vessel 1400b and includes straps 1420 with fasteners 1422. The heating device may include a control panel to control the heating temperature supplied by the heating device 1416.

In some methods described herein below, the heating device 1416 is applied after the precipitates crash-out of solution to the bottom of the synthesis volume. In one embodiment, the heat may be applied essentially immediately after all of the ingredients are added to the vessel to make the amount of solution.

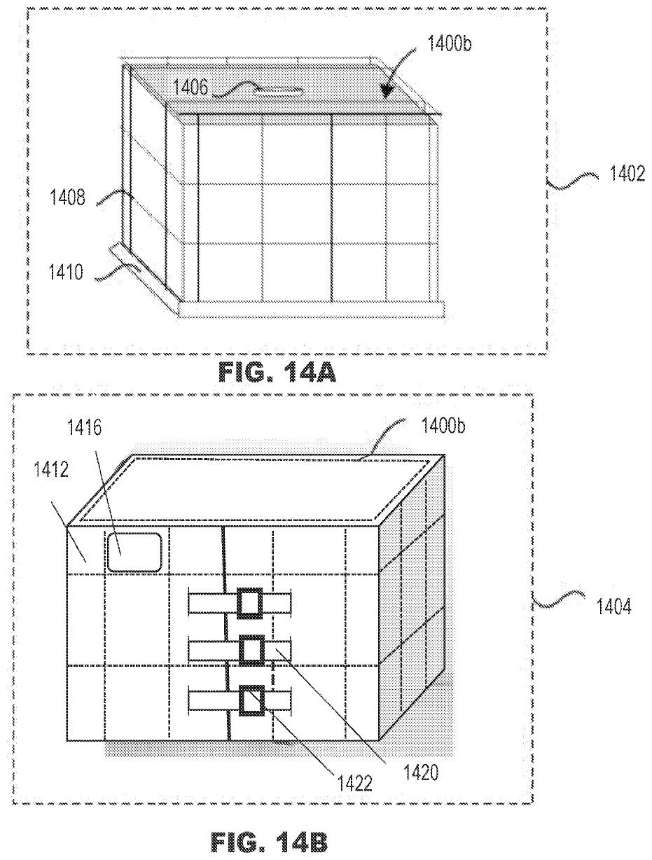

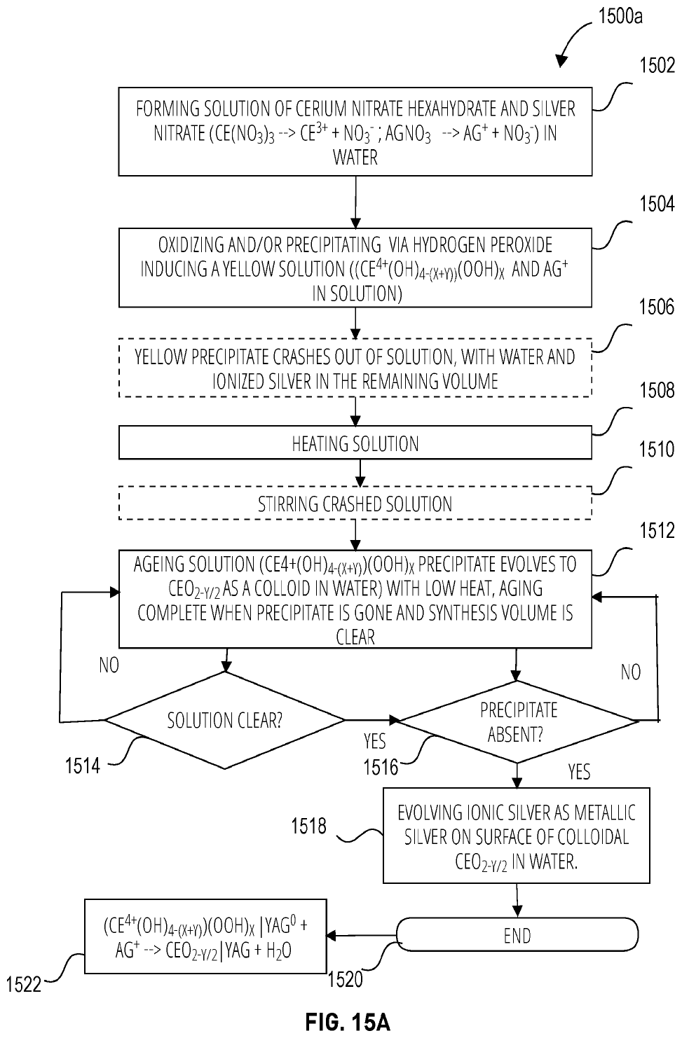

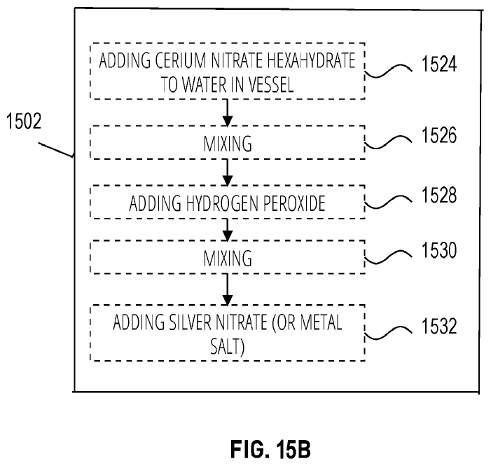

FIG. 15A illustrates a method 1500 for manufacturing AgCNP2 with a predominant Ce 3+ charge in accordance with one embodiment. Although method 1500 depicts a particular sequence of operations, the sequence may be altered without departing from the scope of the present disclosure. For example, some of the operations depicted may be performed in parallel or in a different sequence that does not materially affect the function of the method 1500. In other examples, different components of an example device or system that implements the method 1500 may perform functions at substantially the same time or in a specific sequence.

According to some examples, the method 1500 includes forming an initial solution that may be comprised of cerium nitrate hexahydrate and silver nitrate (Ce(NO₃)₃→Ce³⁺+NO₃⁻; AgNO₃→Ag⁺+NO₃⁻) at block 1502. The initial solution may form un-aged cerium oxide nanoparticles. By way of non-limiting example, after block 1502, the system (vessel) may be closed such that no additional ingredients to the solution are added. However, a stirrer may be used to stir ingredients to homogenize the ingredients within the solution.

According to some examples, the method 1500 includes oxidizing and precipitating via hydrogen peroxide inducing a yellow solution evolving as the initial cerium peroxy ligand is formed ((Ce⁴⁺(OH)_{4-(x+y))}(OOH)ₓ and Ag⁺ in synthesizing solution) at block 1504. Full or brightest yellow color occurs within 12-24 hours of initial mixing, with the mixture initially starting clear and gradually attaining yellow color. According to some examples, the method 1500 may include yellowing precipitate crashing out of solution, with water and ionized silver in the remaining volume at block 1506. Block 1506 is optional. Therefore, the block is represented in dashed lines.

According to some examples, the method 1500 may include heating the solution in the vessel at block 1508. The heating the solution is an accelerant that speeds up ageing by a factor of 3 or higher. According to some examples, the method 1500 may include stirring the crashed solution at block 1510, such as while it is being heated. The block 1510 is denoted in a dashed line to denote that stirring is an optional in some embodiments. It should be understood that if the stirring is needed, it needs to be performed so that the solution crashes out. The heat is an accelerant and remains applied to the solution after the stirring may stop. However, after the full amount of the solution is created, the system is shut off to form a closed system.

In one example, when regular hydrogen peroxide is used, the solution is induced to yellow and then it crashes out and precipitates are formed. In another example, wholly un-stabilized hydrogen peroxide is used. In this example, the solution is induced to yellow with essentially no precipitates form and no precipitate crash out occurs.

According to some examples, the method may include ageing solution (Ce⁴⁺(OH)_{4-(x+y)})(OOH)ₓ precipitate evolves to CeO_{2-y/2} as a colloid in water. This may take place with the low heat from the heating device (FIG. 13 or 14B) during block 1508. Ageing is complete when precipitates are gone and/or synthesis volume is clear at block 1512. At bock 1512, in some examples, precipitates are not formed so a determination for determining whether precipitates are gone is eliminated or skipped.

According to some examples, the method 1500 may include determining whether the solution is clear at decision block 1514. If the determination is “NO,” the method returns to block 1512 where ageing continues with heat. If the determination is “YES,” the method 1500 includes determining whether precipitate is absent at decision block 1516. If the determination is “NO,” the method returns to block 1512. If the determination is “YES,” the method 1500 has completed evolving ionic silver as metallic silver on surface of colloidal CeO_{2-y/2} in deionized water or synthesizing solution at block 1518.

According to some examples, the method includes ending at block 1520.

According to some examples, the resultant product includes (Ce⁴⁺(OH)_{4-(x+y)})(OOH)ₓ|yAg⁰+Ag⁺→CeO_{2-y/2}|yAg+H₂O at block 1522 and can remain in the same vessel used to age the solution.

FIG. 15B illustrates a flowchart of a method 1502 for forming an initial solution (at block 1502) of FIG. 15A in accordance with one embodiment. FIG. 15B illustrates an example routine. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method 1502 may include adding cerium nitrate hexahydrate to deionized water in the vessel at block 1524. According to some examples, the method 1502 may include mixing at block 1526 to mix the cerium nitrate hexahydrate and the deionized water. To form the initial solution, deionized water needs to be added to the vessel as the medium to form the solution. In general, the deionized water is added to the vessel first.

According to some examples, the method 1502 may include adding hydrogen peroxide at block 1528. According to some examples, the method includes mixing at block 1530. In some embodiments, the hydrogen peroxide may be added to the vessel before adding cerium nitrate hexahydrate. The hydrogen peroxide at block 1528 should have a concentration of 3-5%. If the hydrogen peroxide has a concentration greater than 5%, the hydrogen peroxide should be diluted before adding to the solution in the vessel. Still further, if hydrogen peroxide has a concentration greater than 5% it may be added as a first ingredient to the deionized water such that the concentration is automatically diluted by the amount of deionized water in the vessel. It is not recommended to add silver nitrate with hydrogen peroxide before cerium nitrate being added to the volume of solution.

According to some examples, the method 1502 may include adding silver nitrate (or metal salt) at block 1532 to form an initial solution. In some examples, the silver nitrate may be added, after block 1502 of FIG. 15A. For example, the silver nitrate (or metal salt) may be added in block 1502, after the solution yellows in block 1504 or after the solution crashes out of block 1506 when non-wholly un-stabilized hydrogen peroxide is used, where non-wholly un-stabilized hydrogen peroxide is not an accelerant.

In some embodiments, the use of food grade hydrogen peroxide in lieu of other types of hydrogen peroxide eliminates the need for stirring at block 1510 in FIG. 15A. In other words, mixing and stirring is only needed to form the initial solution with the food grade hydrogen peroxide or wholly un-stabilized hydrogen peroxide used as an accelerant.

In some embodiments, stirring is needed with any method described herein that uses a non-food grade hydrogen peroxide or non-wholly un-stabilized hydrogen peroxide. While not wishing to be bound by theory, food grade hydrogen peroxide or wholly un-stabilized hydrogen peroxide induces a yellowing of the solution but does not cause precipitates to form that need to be stirred to allow the peroxy ligand to access water to promote the evolution of ionized silver to non-ionized silver.

In some embodiments, when heating is used as an accelerant the heating is applied after the crash-out of the precipitates in methods that use non-food grade hydrogen peroxide or non-wholly un-stabilized hydrogen peroxide. As discussed previously, food grade hydrogen peroxide or wholly un-stabilized hydrogen peroxide induces a yellowing of the solution but does not cause precipitates to form. Therefore, if heat is used, there is no need for a delay and can be applied immediately.

In some embodiments, the selection of the vessel may be an accelerant so that the precipitates can have improved access to water of the solution to speed up the ageing process such that all, to 1 ppm or less of the limit of detection, ionizing silver evolves to a non-ionizing silver phase.

The formulation of cerium oxide nanoparticles is produced with surfaces modified by stable metallic silver nanophases. Materials characterization shows that the silver components in each formulation are unique from each other and decorate the ceria surface as a Janus-type two-phase construct. The average diameter of AgCNP2 is about 20 nm to 35 nm. The crystallite sizes are 3-5 nm, which can also be the particle size in some instances. In some methods the crystallites agglomerate together, so the crystallite size is the same).

For example, an AgCNP2 ingredient is a preferred form of AgCNP for high touch surfaces, including toilets, sinks, door handles, walls, faucets, hard surfaces, cages, etc.

Each synthesis further possesses unique mixed valency with AgCNP2 possessing a significantly greater fraction of Ce3+ states relative to Ce4+ over catalase mimetic AgCNP1. The distinct valence characters, along with incorporation of chemically active silver phases, lead to high catalytic activities for each formulation. AgCNP2 possesses high superoxide dismutase activity.

There are a variety of methods to synthesize nanoceria particles, including wet chemical, solvothermal, microemulsion, precipitation, hydrolysis and hydrothermal, such as described in S. Das, et al., “Cerium oxide nanoparticles: applications and prospects in nanomedicine,” Nanomedicine 8(9) (2013) 1483-1508 and C. Sun, et al. “Nanostructured ceria-based materials: synthesis, properties, and applications,” Energy & Environmental Science 5(9) (2012) 8475-8505, both of which are incorporated herein by reference. Based on the synthesis methodology employed, the size of these NPs varies broadly from 3-5 nm to over 100 nm, and the surface charge can vary from −57 mV to +45 mV.

Further, analysis demonstrates that silver incorporated in each formulation is substantially more stable to redox-mediated degradation than pure silver phases: promoting an increased lifetime in catalytic applications and low probability of ionization of the silver phase.

Use of AgCNP2 formulation in effecting antimicrobial properties showed specific activity in tests associated with bacteria with, among bacteria species tested, AgCNP2 showing substantial activity towards Staphylococcus mutans, such as Staphylococcus aureus.

Although the amount is not intended to be limiting, when used in methods of the invention, some preferred amounts of silver percentages associated with the AgCNP2 being about 8% to 15% or less.

In some embodiments, the AgCNP2 of the NanoRAD ingredient is produced via a method comprising dissolving cerium and silver precursor salts such as cerium and silver nitrates and oxidizing the dissolved cerium and silver precursor salts. The cerium precursor salts are dissolved prior to silver salt. The purity on cerium nitrate hexahydrate can be as low as 99.9% with the silver purity also at 99.9%.

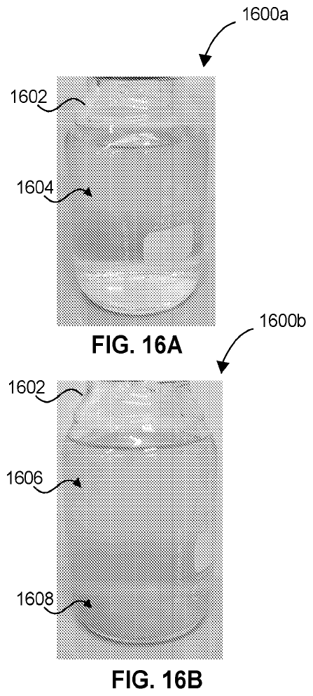

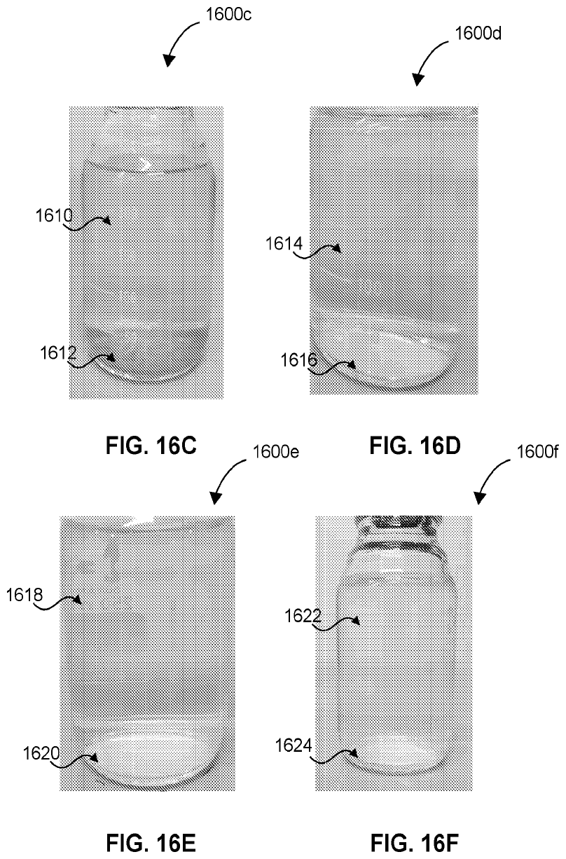

FIGS. 16A-16G illustrates images 1600a, 1600b, 1600c, 1600d, 1600e, 1600f and 1600g of different phases of the solutions of the method 1500 with heating at block 1508. For the purposes of explanation, the container is a glass container that is transparent and holds 250 mL. This container in FIGS. 16A-16G is chosen so that the different changes to the solution can be seen. The methods herein are preferably used to make large volumes of AgCNP2 colloidal solution with concentration of 1×-8×.

Using a 275 gallon vessel, the solution at 1× concentration of 250 gallons of AgCNP2 includes:
960 L of deionized water (diH₂O);
2.18 kg (kilograms) of cerium nitrate hexahydrate;
169.87 g (grams) of silver nitrate; and
40 L of food grade hydrogen peroxide (H2O2) at 3% concentration.

These ratios hold for the different embodiments. In an embodiments for a 4× concentration of AgCNP2, the total fluid volume is held at 1000 L, but the cerium nitrate hexahydrate, silver nitrate, and hydrogen peroxide are increased by a factor of 4.

The process shown in FIGS. 16A-16G does not use an FF ratio for the vessel. In FIG. 16A-16G the at least one accelerant is low heat.

FIG. 16A illustrates an image 1600a of a first solution 1604 of cerium nitrate hexahydrate, silver nitrate, and hydrogen peroxide in a container in accordance with one embodiment. The image 1600a is of the first solution at Day 1 in a container 1602. The deionized water may be at 14 MΩ (Mega Ohms) and may be between 12-18 MΩ. The hydrogen peroxide may be in concentration from about 3% to about 35% or more and is diluted to 3%-5% with deionized water (diH₂O) when in concentrations greater than 5%. In this example, regular hydrogen peroxide was used, which causes precipitates to form in a crash-out phase.

FIG. 16B illustrates an image 1600b of the yellowing of the solution 1604 of FIG. 16A in a container in accordance with one embodiment. The yellow solution 1606 is a batch appearance that turns to an orange yellow and begins to precipitate where the precipitates 1608 sink to the bottom of container 302. The yellow solution 1606 of image 1600b occurs generally between Days 2-4. The yellowing precipitate 1608 crashes out of the first solution 1604, with water and ionized silver in the remaining volume of the solution 1606.

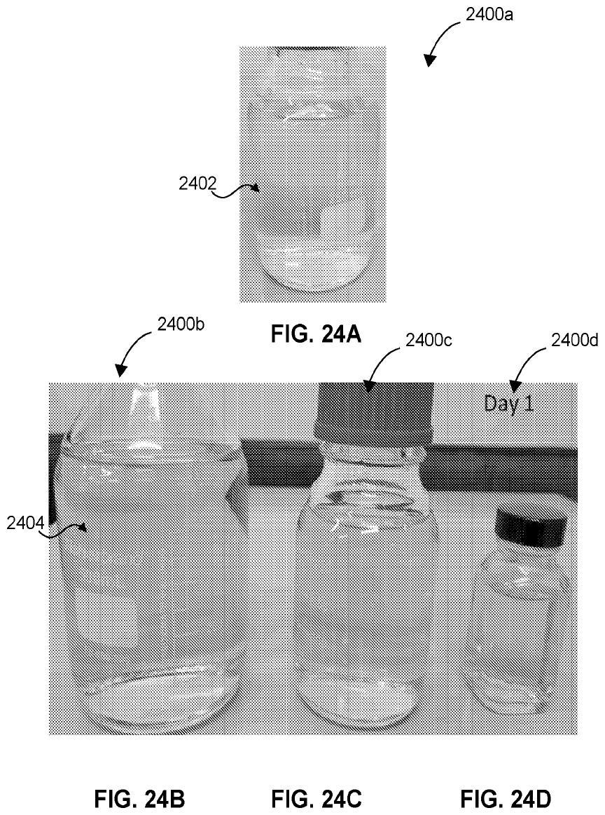

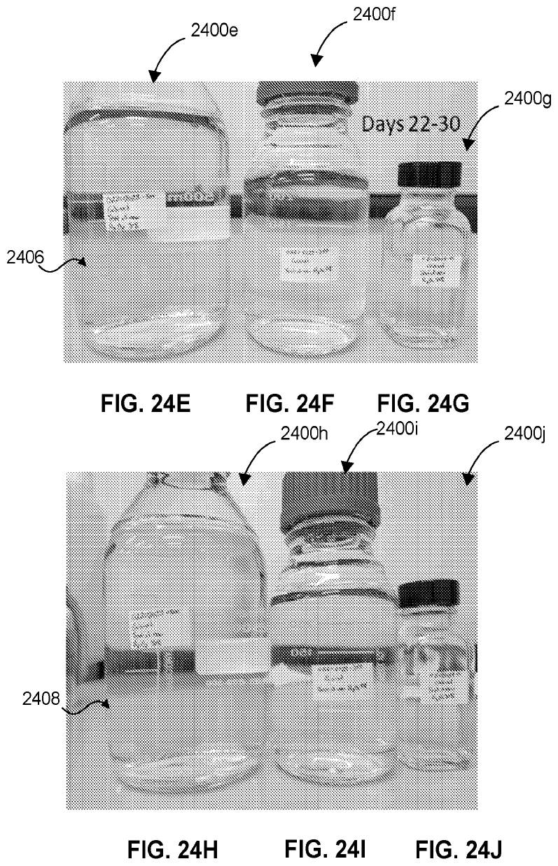

As will be discuses in FIGS. 24A-24J, when food grade or wholly un-stabilized hydrogen peroxide, no crashing precipitate occurs and instead, the reaction volume loses color over time, as will be described in relation to FIGS. 24A-24J.

FIG. 16C illustrates an image 1600c of the solution of FIG. 16A after 4-5 days. The batch appearance of the solution 1610 turns clear with an orange-yellow precipitate 1612 settled on the bottom. Once the crash-out phase occurs the heat may be applied to the container/vessel to heat the solution in the closed system.

FIG. 16D illustrates an image 1600d of the solution of FIG. 16A after 45-60 days. The batch appearance of the solution 514 stays clear with most orange-yellow precipitate 516 re-precipitated as colloid, and about 10% remains settled.

FIG. 16E illustrates an image 1600e of the solution of FIG. 16A after 75-90 days. The batch appearance of the solution 1618 stays clear with most orange-yellow precipitate 1620 re-precipitated as colloid, and about 5% remains settled. The settled precipitate 1622 has a fuzzy appearance.

FIG. 16F illustrates an image 1600f of the solution of FIG. 16A after 90-120 days. The batch appearance of the solution 1622 stays clear with most orange-yellow precipitate 1624 re-precipitated as colloid, and about 1-3% remains settled. The disturbed sediment has a smokey look when stirred into the fluid.

FIG. 16G illustrates an image 1600g of the solution of FIG. 16A after 120 days. The batch appearance of the solution 1626 is clear with no precipitate.

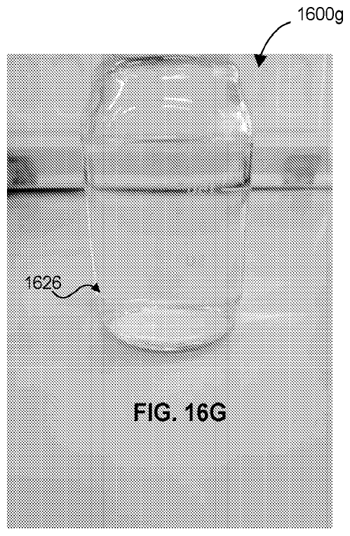

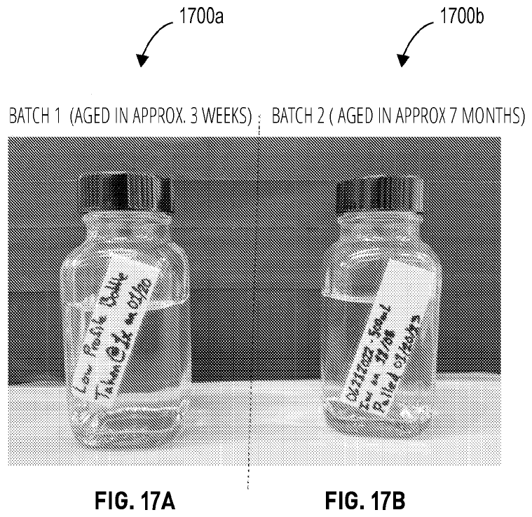

FIG. 17A illustrates an image 1700a of an aged solution including non-ionizing and non-ionized silver in a container after 3 months using the method 1500 of FIG. 15A in accordance with one embodiment. The method 1500 used low heat at block 1508 and generally continuously for 3 months, until the ageing process was complete.

FIG. 17B illustrates an image 1700b of an aged solution including non-ionizing and non-ionized silver after 7 months in a container using the original synthesis method.

FIGS. 18A, 18B, and 18C illustrate images 1800a, 1800b and 1800c of E. Coli liquid tests based on the aged solution of FIG. 17A using 0.05 mg/mL of AgCNP2 in accordance with one embodiment. The tests are for 0, 10, 30, 60 and 120 days.

FIGS. 18D, 18E, and 18F illustrate images 1800d, 1800e and 1800f of E. Coli liquid tests based on the aged solution of FIG. 17A using 0.1 mg/mL AgCNP2 in accordance with one embodiment. The tests are for 0, 10, 30, 60 and 120 days.

FIGS. 18G, 18H, and 18I illustrate images 1800g, 1800h and 1800i of E. Coli liquid tests based on the aged solution of FIG. 17A using 0.2 mg/mL AgCNP2 in accordance with one embodiment. The tests are for 0, 10, 30, 60 and 120 days.

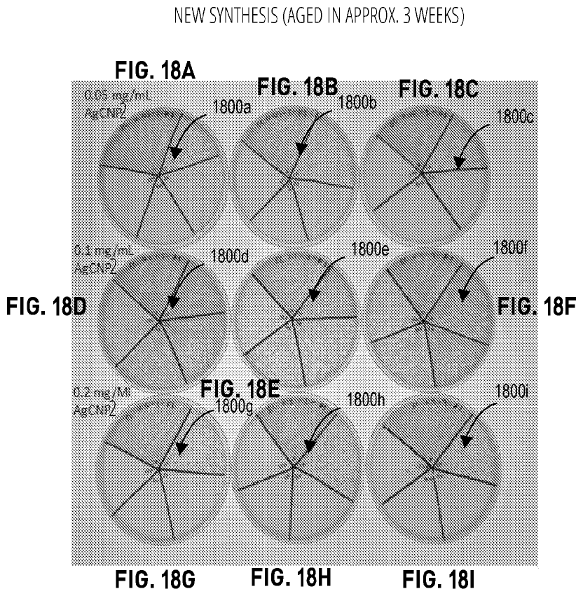

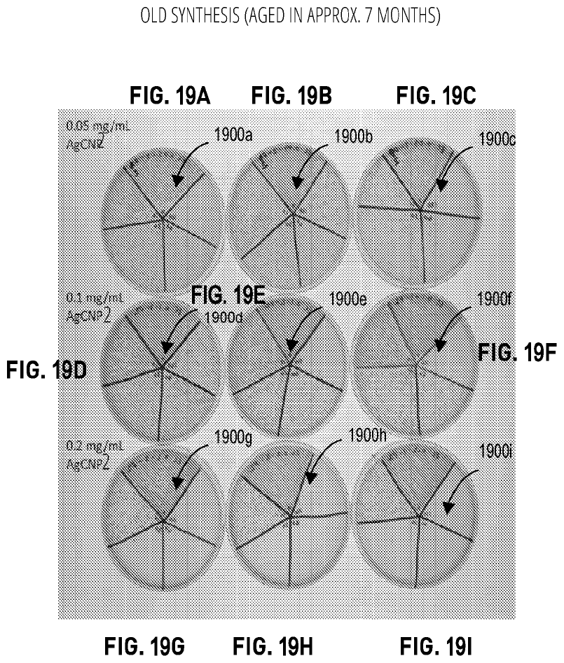

FIGS. 19A, 19B, and 19C illustrate images 1900a, 1900b and 1900c of E. Coli liquid tests based on the aged solution of FIG. 17B using 0.05 mg/mL of AgCNP2 in accordance with one embodiment. The tests are for 0, 10, 30, 60 and 120 days.

FIGS. 19D, 19E, and 19F illustrate images 1900d, 1900e and 1900f of E. Coli liquid tests based on the aged solution of FIG. 17B using 0.1 mg/mL AgCNP2 in accordance with one embodiment. The tests are for 0, 10, 30, 60 and 120 days.

FIGS. 19G, 19H, and 19I illustrate images 1900g, 1900h and 1900i of E. Coli liquid tests based on the aged solution of FIG. 17B using 0.2 mg/mL AgCNP2 in accordance with one embodiment. The tests are for 0, 10, 30, 60 and 120 days.

FIGS. 18A-18I of the new synthesis and FIGS. 19A-19I of the original synthesis can be compared. It shows that the minimum inhibitory concentration and SOD activity are essentially unchanged between the two syntheses. In other words, the AgCNP2 manufactured by the new synthesis and the old synthesis have the SOD mimetic and inhibitory characteristics at essentially the same concentration.

The bottles of FIGS. 17A and 17B are volumes of fluid removed from the larger containers for the test. The same volume (500 ml) for the original synthesis or 10x the original synthesis in the WO2021222779A1 document. It can be seen that the aging time increased significantly from the 50 ml synthesis (6-8 weeks) to 7 months at room temperature.

The new synthesis is 1 L of AgCNP2 batch (20× the original synthesis) but this was done in a low profile container with dimensions of 10″wide×15″.5 high×2.75″ deep. The container was laid on its side so that the bottom area of the container was ˜10″×15″ with a synthesis fill height of 1.5″ (total container height 2.75″) and finished aging at 3 weeks. The difference in ageing times is 3 weeks versus 7 months. The new process used heat as an accelerant at 95° F. after precipitate crashed out. The solution of the new synthesis aged in less than half the time at 20× the original synthesis volume. The container is from Hudson Exchange 5 Liter Hedpak Container with Cap, HDPE, Natural, 4 Pack available from Amazon.com.

The original synthesis used a cylindrical glass bottle (similar to original synthesis in terms of low surface area to volume), not heated. Aging time was nearly 4× the aging time at 50 ml.

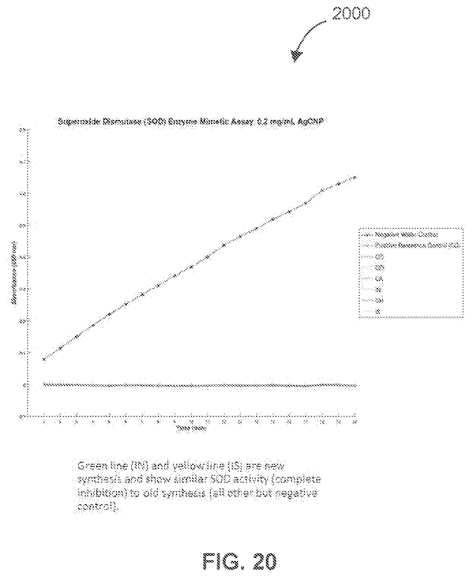

FIG. 20 illustrates a graph 2000 of superoxide dismutase (SOD) Enzyme Mimetic Assay for 0.2 mg/mL of AgCNP2 in accordance with one embodiment.

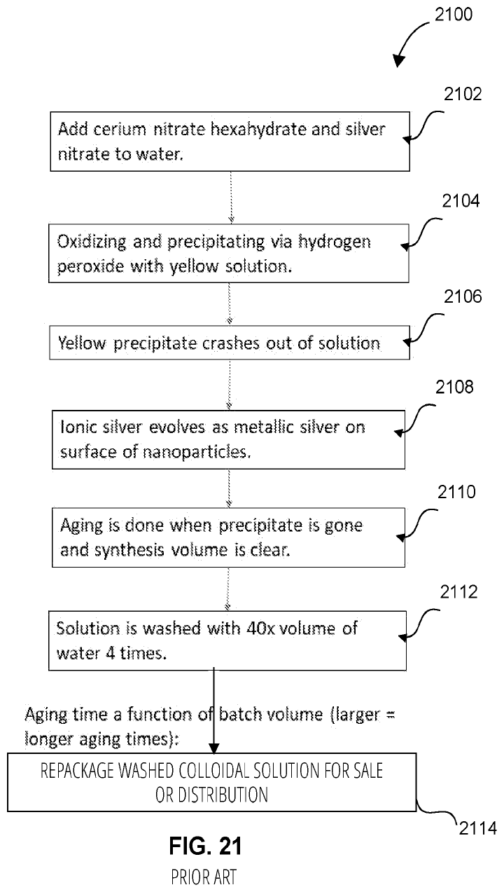

FIG. 21 illustrates a flowchart 2100 of a prior art method for forming AgCNP2. The method 2100 includes forming solution of cerium nitrate hexahydrate and silver nitrate (Ce(NO₃)₃→Ce³⁺+NO₃⁻; AgNO₃→Ag⁺+NO₃⁻) at block 2102.

According to some examples, the method 2100 includes oxidizing and precipitating via regular hydrogen peroxide which gradually changes the color of the solution from clear to yellow over a 12-24 hour period ((Ce⁴⁺(OH)_{4-(x+y))}(OOH)ₓ and Ag⁺ in synthesizing solution) at block 2104. The method 2100 includes yellowing precipitate crashing out of solution, with water and ionized silver in the remaining volume at block 2106.

The method 2100 includes evolving metallic silver onto the cerium oxide nanoparticles block 2108 and ageing when precipitate is gone and synthesis volume is clear at 2110, where the solution includes (Ce⁴⁺(OH)_{4-(x+y)})(OOH)ₓ|yAg⁰+Ag⁺→CeO_{2-y/2}|yAg+H₂O+Ag⁺. However, it was discovered that not all ionized silver has evolved to non-ionizing metallic silver such as, to 1 ppm or less of the limit of detection.

The method 2100 includes washing the aged solution with 40× volume of water 4 times at block 2112. In this process, a 50 mL volume is processed in 12-20 weeks and 1 L processed in 28-52 weeks. Inventors believe these different aging times are related to changes in storage temperatures experienced by different batches depending on where they were stored for aging. At block 2114, the washed colloidal solution with AgCNP2 is packaged for sale or distribution. At room temperature, the accelerated aging is not expected because room temperature is between 70-75° F.

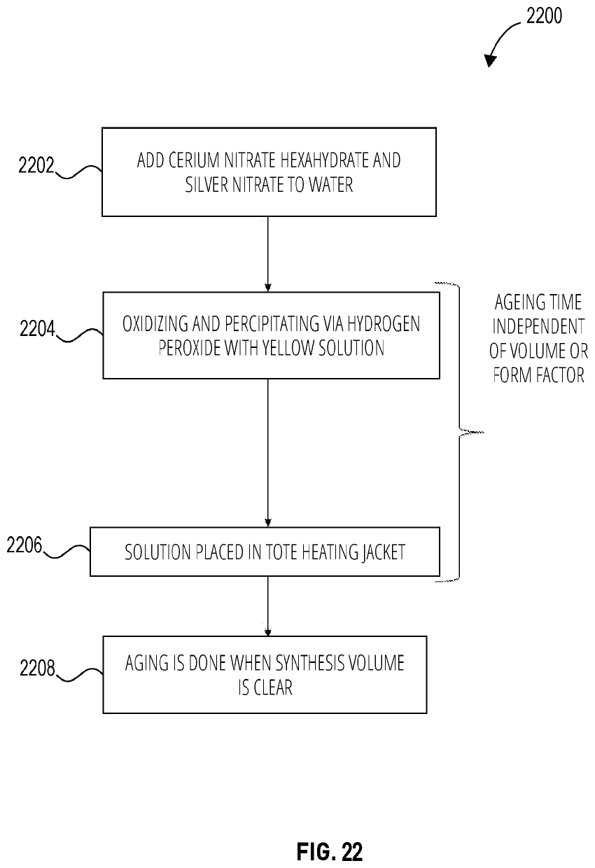

FIG. 22 illustrates a flowchart 2200 of a method for forming AgCNP2 with a predominant Ce 3+ charge using a heat application in accordance with one embodiment. Although the method 2200 depicts a particular sequence of operations, the sequence may be altered without departing from the scope of the present disclosure. For example, some of the operations depicted may be performed in parallel or in a different sequence that does not materially affect the function of the method 2200. In other examples, different components of an example device or system that implements the method 2200 may perform functions at substantially the same time or in a specific sequence.

According to some examples, the method 2200 includes forming solution of cerium nitrate hexahydrate and silver nitrate in water at block 2202. In some embodiments, formed solution include deionized water (dH₂O), Ce(NO3)3.6H₂O, and AgNO3 to the vessel. Light mixing may be applied to homogenize the batch solution.

According to some examples, the method 2200 includes oxidizing and precipitating via regular hydrogen peroxide inducing a yellow solution going from clear to yellow over a 12-24 hour period at block 2204. The H₂O₂ is wholly un-stabilized or food grade H₂O₂ and may be diluted with deionized water to 3%-5% when in concentrations greater than 5%. When forming the solution, the ingredients are mixed or stirred in the vessel. Light mixing may be applied to homogenize the batch solution.

The method 2200 also applies to a solution that is formed with wholly un-stabilized hydrogen peroxide. Depending on the order of forming the initial solution and whether the addition of the wholly un-stabilized or food grade H₂O₂ occurs first, the entry may be diluted by the deionized water in the initial solution. However, if the wholly un-stabilized or food grade H₂O₂ is added at any other time of forming the initial solution, then the wholly un-stabilized or food grade H₂O₂ needs to be diluted before being added to the vessel.

According to some examples, the method 2200 includes heating the solution at block 2206. The heating of the solution for the aging period speeds up ageing by factor 6. In some embodiments, the heating device such as the jacket shown in FIG. 14B is placed around the vessel to heat the solution to about 90°-115° F.

According to some examples, the method 2200 includes ageing the solution while heat is applied. Ageing is complete when synthesis volume is clear at block 2208. The inventors have surprisingly determined that using food grade hydrogen peroxide or a wholly un-stabilized hydrogen peroxide can speed up the process in combination with heat application. In an embodiment, where food grade hydrogen peroxide or a wholly un-stabilized hydrogen peroxide is used in the solution, there is no delay needed in adding heat which speeds up the overall time for ageing as compared to the time to manufacture using regular hydrogen peroxide.

By way of non-limiting example, the manufactured volume is independent for aging, aging instead is dependent on concentration above original synthesis (1×) when wholly un-stabilized hydrogen peroxide is used. A solution with a concentration of 1×˜21 days to age; a concentration of 4×˜30 days to age; and a concentration of 8×˜45 days to age. Aging time is correlated to concentration as opposed to synthesis volume.

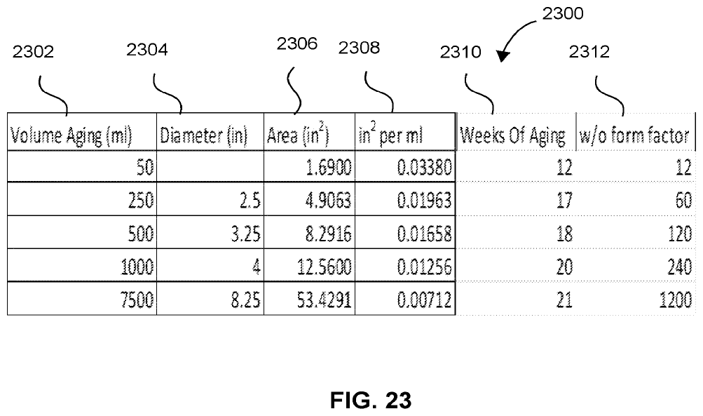

FIG. 23 illustrates a table 2300 of ageing time relative to solution amount and form factor ratio with heating to 95° F. in accordance with one embodiment. In this embodiment, the solution included regular hydrogen peroxide. The solution of FIG. 23 used regular hydrogen peroxide. The table 2300 includes a column 2302 for a volume aging (mL); column 2304, diameter of aging vessel (in); column 2306, Area of bottom surface of aging vessel (in²); column 2308, in² per mL; column 2310, weeks of ageing; and column 2312, without vessel form factor.

The ageing volumes (mL) include 50, 250, 500, 1000 and 7500. The diameter of the vessel for 250 mL was 2.5 in; 500 mL was 3.25 in; 1000 mL was 4 in; and 7500 mL was 8.25 in. The area was 1.690, 4.9063, 8.2916, 12.5600, and 53.4291. The in² per mL is 0.3380, 0.01963, 0.01658, 0.01256, and 0.00712.

The number of weeks for ageing volumes (mL) includes 12 for 50 mL, 17 for 250 mL, 18 for 500 mL, 20 for 1000 mL, and 21 for 7500 mL based on a form factor with W/H>1, for example. However, the ageing time was longer for larger batches of solution. For example, the weeks of aging volumes for 250 mL was 60 weeks; 500 mL was 120 weeks; 1000 mL was 240 weeks and 7500 mL was 1200 weeks of aging.

FIG. 24A illustrates an image 2400a of a solution 2402 of cerium nitrate hexahydrate, silver nitrate, and hydrogen peroxide in a container in accordance with one embodiment. The solution has a generally faint yellowish tint when the precursors and wholly un-stabilized hydrogen peroxide are initially mixed into the container.

FIGS. 24B-24D illustrate images 2400b, 2400c, and 2400d of the solution 2404 of FIG. 24A in different volume containers, large, medium, and small, at the end of day 1 in accordance with one embodiment. The solution 2404 in each container is at peak color for the synthesis as an orange-yellow with no readily detectable precipitation formed.

FIGS. 24E-24G illustrate images 2400e, 2400f, and 2400g of the solution 2406 of FIG. 24A in different volume containers, large, medium, and small, 3 weeks into aging in accordance with one embodiment. The solution 2406 in each container has no readily detectable precipitation formed. The color of the solution has faded as colloids form with a faint yellowish tint.

FIG. 24H-24J illustrate images 2400h, 2400i, and 2400j of the solution 2408 of FIG. 24A in different volume containers, large, medium, and small, 4 weeks into the aging process in accordance with one embodiment. The solution 2408 in each container has no readily detectable precipitation formed, and the solution is clear.

The images of FIGS. 24A-24J represent that the form factor of the vessel does not affect the acceleration of the ageing of the solution to evolve all, to 1 ppm or less of the limit of detection, ionizing silver to non-ionizing silver to complete the formation of AgCNP2 without the need to wash.

In one embodiment, a method for manufacturing silver-modified cerium oxide nanoparticles (AgCNP2) is provided that includes using a process with at least one accelerant adapted for use in a closed system that speeds up the peroxy ligand conversion of AgCNP2 having a predominant 3+ cerium charge, the at least one accelerant accelerates evolution of all, to 1ppm or less of the limit of detection, ionized Ag to crystallize onto cerium oxide nanoparticles as a non-ionized metallic silver phase with no waste material byproduct that is greater than 1 ppm of ionized silver.

In one embodiment, a method for manufacturing silver-modified cerium oxide nanoparticles (AgCNP2) is provided that includes mixing in a single vessel cerium nitrate hexahydrate and silver nitrate to form a solution; applying an accelerant to the solution; and forming from the solution the AgCNP2 having a predominant 3+ cerium charge, the accelerant accelerates evolution of all, to 1 ppm or less of the limit of detection, ionized Ag to crystallize onto cerium oxide nanoparticles as a non-ionized metallic silver phase without any waste material byproduct that is greater than 1 ppm of ionized silver.

In one embodiment, the accelerant is selected from the group consisting of: applying low heat of 90°-115° F. during an aging process within a closed system during which peroxy ligand conversion takes place; and adding a food grade hydrogen peroxide or a wholly un-stabilized hydrogen peroxide to a mixture prior to the aging process in the closed system.

Embodiments herein relate to large-scale manufacturing processes for silver-mediated cerium oxide nanoparticles in a closed system without washing the aged solution and where no waste material byproduct remains that is greater than 1 ppm of ionized silver. The manufacturing processes use at least one accelerate to speed up peroxy ligand conversion of AgCNP2 wherein the AgCNP2 and a spore germination agent are mixed in a coating composition for coating surfaces

The embodiments herein include a method for manufacturing silver-modified cerium oxide nanoparticles (AgCNP2) for a coating composition for coating surfaces. The method includes ageing in a closed system un-aged cerium oxide nanoparticles in a solution that includes silver nitrate and uses at least one accelerant. The at least one accelerant speeds up peroxy ligand conversion of cerium oxide nanoparticles (CNP) having a predominant 3+ cerium charge and accelerates evolution of all, to 1 ppm or less of the limit of detection, ionized Ag to crystallize onto cerium oxide nanoparticles as a non-ionized stable metallic silver phase to form the AgCNP2. The at least one accelerant is selected from the group consisting of: low heat of 90°-115° F. applied to the closed system to heat the solution only after crash-out of the solution that is without an ingredient that incudes wholly un-stabilized hydrogen peroxide; wholly un-stabilized hydrogen peroxide mixed in the solution prior to aging by the closed system; low heat of 90°-115° F. applied to the closed system to heat the solution that incudes wholly un-stabilized hydrogen peroxide; and a form factor (FF) ratio of a vessel of the closed system where the ageing takes place.

The embodiments include a formulation comprising a first composition (i.e., water-based coating polymer) mixed with silver-modified cerium oxide nanoparticles (AgCNP2). The AgCNP2 includes a predominant 3+ surface charge and in a range of about 3-35 nanometers (nm) in size. The AgCNP2 produced with a method that includes at least one accelerant that speeds up peroxy ligand conversion of AgCNP2. The formulation also includes a spore germination agent.

In an embodiment, the selected AgCNPs having a predominant 3+ surface charge and in a range of about 25-35 nanometers (nm) in size.

The formulation is a coating that is a continuous self-disinfecting and pathogen eradicating coatings that prevents microbe colonization of a surface using a long-lasting coating composition. The coating once cured has a strong bond with the surface to which it is adhered to so that the coating can withstand washing with water and soap over multiple cleanings. More importantly, the coating is non-re-hydrating once cured.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

Embodiments are described herein with reference to the attached figures wherein like reference numerals are used throughout the figures to designate similar or equivalent elements. In some instances, figures are not drawn to scale and they are provided merely to illustrate aspects disclosed herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claimed is:

1. A coating composition comprising a mixture of a water-based coating polymer;
an aqueous solution having silver-modified ceria nanoparticles (AgCNPs) and a weight percent loading less than about 3% weight/volume of the mixture, and a spore germination agent having a 0.01-3% weight/volume of the mixture and the mixture configured for coating a surface.

2. The coating composition of claim 1, wherein the mixture is configured to be cured with a UV light or hardened by drying.

3. The coating composition of claim 1, wherein the AgCNPs are AgCNP2 having a predominant 3+ surface charge and in a range of about 25-35 nanometers (nm) in size.

4. The coating composition of claim 1, wherein the spore germination agent mixed in the mixture causes rigidly enclosed bacterium spores to germinate.

5. The coating composition of claim 1, wherein the spore germination agent mixed in the mixture is effective in causing spores of Clostridioides difficile on the surface to germinate.

6. The coating composition of claim 1, wherein the spore germination agent is effective in causing spores of Histoplasma Capsulatum on the surface to germinate.

7. The coating composition of claim 1, wherein the spore germination agent includes a co-germinant.

8. The coating composition of claim 1, wherein the water-based coating polymer includes at least one of paint, epoxy, polyurethane, an acrylic, a polyester, or a vinyl.

9. The coating composition of claim 1, wherein the spore germination agent includes a Bile Salt and taurocholic acid (TCA)/cholic acid derivatives as an initiator for germination.

10. The coating composition of claim 1, wherein the spore germination agent includes co-germinant amino acids.

11. The coating composition of claim 1, wherein the spore germination agent includes glycine in a range of about 0.01-1% wt./volume.

12. The coating composition of claim 1, wherein the spore germination agent includes calcium (Ca²⁺) in a range of 0.01% wt./volume up to 1% wt./volume.

13. The coating composition of claim 1, wherein the AgCNPs are AgCNP2 having a predominant 3+ cerium charge produced via a method comprising:
ageing in a closed system un-aged cerium oxide nanoparticles in the aqueous solution that includes silver nitrate and uses at least one accelerant, the at least one accelerant speeds up peroxy ligand conversion of cerium oxide nanoparticles (CNP) having a predominant 3+ cerium charge and accelerates evolution of all, to 1 ppm or less of a limit of detection, ionized Ag to crystallize onto cerium oxide nanoparticles as a non-ionized metallic silver phase to form the AgCNP2, the at least one accelerant is selected from the group consisting of:
a) low heat of 90°-115° F. applied to the closed system to heat the solution only after crash-out of the solution that is without an ingredient that incudes wholly un-stabilized hydrogen peroxide;
b) wholly un-stabilized hydrogen peroxide mixed in the solution prior to aging in the closed system;
c) low heat of 90°-115° F. applied to the closed system to heat the solution that includes wholly un-stabilized hydrogen peroxide; and
d) a form factor (FF) ratio of a vessel of the closed system where the ageing takes place.

14. The coating composition of claim 13, wherein the at least one accelerant includes the wholly un-stabilized hydrogen peroxide; and
further comprising:
mixing, in a single vessel, water, cerium nitrate hexahydrate, and the silver nitrate to form the solution;
adding the wholly un-stabilized hydrogen peroxide to the solution in the single vessel;
closing the vessel to form a closed system with the solution within the single vessel; and
during the aging, forming from the solution the AgCNP2 having the predominant 3+ cerium charge and in a range of about 3-35 nanometers (nm) in size. the accelerant accelerates evolution of all, to 1 ppm or less of the limit of detection, ionized Ag to crystallize onto cerium oxide nanoparticles as a non-ionized stable metallic silver phase without any waste material byproduct that is greater than 1 ppm of ionized silver.

15. The coating composition of claim 14, wherein the at least one accelerant further includes the low heat of 90°-115° F. applied to the closed system to heat the solution.

16. The coating composition of claim 13, wherein the at least one accelerant includes the FF ratio wherein the FF ratio is W1/HV>1 such that the vessel has a height and an inner width (W1) where a height of a volume (HV) of solution is less than the W1 so that the FF ratio is W1/HV>1.

17. The coating composition of claim 13, wherein the at least one accelerant includes the low heat of 90°-115° F. applied to the closed system to heat the solution only after crash-out of the solution that is without the ingredient that includes the wholly un-stabilized hydrogen peroxide.

18. The coating composition of claim 13, wherein the at least one accelerant includes low heat applied to the solution speeds up ageing by a factor of 3-6.

19. An article of manufacture comprising:
an object having a surface; and
a coating composition of claim 1, cured and bonded on the surface.

20. The article of manufacture of claim 19, wherein the AgCNPs having a predominant 3+ surface charge and in a range of about 25-35 nanometers (nm) in size.

21. The article of manufacture of claim 19, wherein the spore germination agent mixed in the mixture causes rigidly enclosed bacterium spores to germinate.

22. The article of manufacture of claim 19, wherein the spore germination agent mixed in the mixture is effective in causing spores of Clostridioides difficile on the surface of the cured coating to germinate.

23. The article of manufacture of claim 19, wherein the spore germination agent is effective in causing spores of Histoplasma Capsulatum on the surface to germinate.

24. The article of manufacture of claim 19, wherein the spore germination agent includes a co-germinant.

25. The article of manufacture of claim 19, wherein the water-based coating polymer includes at least one of paint, epoxy, polyurethane, an acrylic, a polyester, or a vinyl.

26. The article of manufacture of claim 19, wherein the spore germination agent includes a Bile Salt and taurocholic acid (TCA)/cholic acid derivatives as an initiator for germination.

27. The article of manufacture of claim 19, wherein the spore germination agent includes co-germinant amino acids.

28. The article of manufacture of claim 19, wherein the spore germination agent includes glycine in a range of about 0.01-1% wt./volume.

29. The article of manufacture of claim 19, wherein the spore germination agent includes calcium (Ca²⁺) in a range of 0.01% wt./volume up to 1% wt./volume.
